(19) United States
(12) Patent Application Publication
(10) Pub. No.: US 2002/0008906 A1
(43) Pub. Date: Jan. 24, 2002

(54) Stereoscopic picture displaying apparatus

(76) Inventor: Seijiro Tomita, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/853,209

(22) Filed: May 11, 2001

(30) Foreign Application Priority Data
May 12, 2000 (JP) P2000-141030

(51) Int. Cl. H04N 9/47; H04N 13/04; H04N 15/00; G02B 27/22

(52) U.S. Cl. 359/462; 348/56

(57) ABSTRACT

A stereoscopic picture displaying apparatus comprises a RAM for storing stereoscopic picture data including a right eye picture and a left eye picture, a display for displaying a stereoscopic picture based on the stereoscopic picture data, a mouse for operating a pointer for pointing a prescribed position on a screen of the display, a MPU for controlling the display to display the right eye picture and the left eye picture alternately on the display so as to have a parallax, and a shutter spectacles having a pair of shutters switched between open and closing states in synchronizing with switching timing of the two pictures, wherein the MPU controls the display to display the pointer so as to have a parallax in accordance with the parallax at a pointing position of the pointer when the pointer is located at a prescribed position on the stereoscopic picture.

### RELATED APPLICATION DATA

The present invention claims priority to Japanese Application No. P2000-141030 filed May 12, 2000, which application is incorporated herein by referenced to the extent permitted by law.

### BACKGROUND OF THE INVENTION

1. Field of the Invention

The present invention relates to a stereoscopic picture displaying apparatus enabling a person to stereoscopically look at a photographed picture with a pair of shutter spectacles by photographing picture for a right eye and a picture for a left eye.

2. Description of the Related Art

A conventional stereoscopic picture displaying apparatus that stereoscopically displays a two-dimensional picture displays a picture for a right eye and a picture for a left eye alternately to have a parallax between two pictures on a display, and switches the states of the shutter section for the right eye and the shutter section for the left eye of a pair of shutter spectacles to take a open state and a closing state synchronously with the switching of the pictures displayed alternately on the display. That is, in the shutter spectacles, when the picture for a right eye is displayed on the display, the shutter section for the right eye is made to be the open state and the shutter section for the left eye is made to be the closing state. Moreover, in the shutter spectacles, when the picture for a left eye is displayed on the display, the shutter section for the left eye is made to be the open state and the shutter section for the right eye is made to be the closing state. As described above, the stereoscopic picture displaying apparatus enables an user to stereoscopically look at a picture by synchronizing the turning on and off of the picture displayed on the display and a pair of shutters on the left side and the right side of the shutter spectacles.

By the way, when the above-mentioned stereoscopic picture displaying apparatus is structured by means of a usual personal computer, a keyboard that is character-inputting means and a mouse that is a position-inputting means are provided as an input unit. Consequently, there are a case where a stereoscopic picture is edited with the mouse and a case where characters are input on a stereoscopic picture with the keyboard.

However, for example, if a pointer of the mouse moves on a stereoscopic picture when the stereoscopic picture is displayed on the display, it becomes hard for an user to look at the pointer because the pointer is displayed in flat without any parallax. Moreover, if characters are displayed in flat without any parallax when the character is input on a stereoscopic picture displayed on the display, it becomes hard for an user to look at the characters.

Moreover, when a stereoscopic picture is displayed on a part of a screen on the display, a screen region where there is no stereoscopic picture is displayed in flat. For example, icons and other objects are displayed in the region. Consequently, because the region where the stereoscopic picture is displayed and the region where a flat display mode is performed are simultaneously formed on the same screen, it becomes hard for an user to look at the stereoscopic picture.

### SUMMARY OF THE INVENTION

Accordingly, an object of the present invention is to provide a stereoscopic picture displaying apparatus that makes it easy for an user to look at a stereoscopic picture displayed on a display.

That is, the object of the present invention is to provide a stereoscopic picture displaying apparatus capable of making it easy for an user to look at pointing means on a stereoscopic picture by displaying the pointing means so that the pointing means has also a parallax in accordance with the parallax of the stereoscopic picture at the position where a pointing means is located when the pointing means is on the stereoscopic picture.

Moreover, another object of the present invention is to provide a stereoscopic picture displaying apparatus capable of making it easy for an user to look at characters displayed on a stereoscopic picture by displaying the characters so that the character has a parallax in accordance with the amount of the parallax of the stereoscopic picture at the position where the characters are displayed when the characters are displayed on the stereoscopic picture.

Moreover, still another object of the present invention is to provide a stereoscopic picture displaying apparatus making it easy for an user to look at a stereoscopic picture by displaying a frame body having a parallax around the stereoscopic picture displayed on display means.

According to the present invention, the foregoing and other objects and advantages are attained by a stereoscopic picture displaying apparatus that comprises: memory means for storing data of a stereoscopic picture including a picture for a right eye and a picture for a left eye; display means for displaying the picture for a right eye and the picture for a left eye on a basis of the data of the stereoscopic picture stored in the memory means; position-inputting means for operating pointing means for pointing a prescribed position on a screen to the display means; and controlling means for controlling the display means to display the picture for a right eye and the picture for a left eye alternately on the display means so as to have a parallax. Then, the controlling means controls the display means to display the pointing means so as to have a parallax in accordance with an amount of the parallax at a pointing position of the pointing means when the pointing means is located at a prescribed position on the stereoscopic picture.

In accordance with another aspect of the present invention, the foregoing and other objects and advantages are attained by a stereoscopic picture displaying apparatus that comprises: memory means for storing data of a stereoscopic picture including a picture for a right eye and a picture for a left eye; display means for displaying the picture for a right eye and the picture for a left eye on a basis of the data of the stereoscopic picture stored in the memory means; character-inputting means for inputting a character to be displayed on a screen to the display means; and controlling means for controlling the display means to display the picture for a right eye and the picture for a left eye alternately on the display means so as to have a parallax. Then, the controlling means controls the display means to display a character so as to have a parallax in accordance with an amount of the parallax at a position at which the character is input on the screen when the character is input at a prescribed position on the stereoscopic picture with the character-inputting means. In accordance with a further aspect of the present invention, the foregoing and other objects and advantages are attained by a stereoscopic picture displaying apparatus that comprises: memory means for storing data of a stereoscopic picture including a picture for a right eye and a picture for a left eye; display means for displaying the picture for a right eye and the picture for a left eye on a basis of the data of the stereoscopic picture stored in the memory means; and controlling means for controlling the display means to display the picture for a right eye and the picture for a left eye alternately on the display means so as to have a parallax. Then, the controlling means controls the display means to display a frame body, which has a parallax, around the stereoscopic picture including the picture for a right eye and the picture for a left eye when the picture for a right eye and the picture for a left eye are alternately displayed on the display means so as to have the parallax.

According to the stereoscopic picture displaying apparatus of an aspect of the present invention, controlling means controls display means to display pointing means so as to have a parallax in accordance with the amount of a parallax at a pointing position of pointing means when the pointing means is located at a prescribed position on a stereoscopic picture. Consequently, the pointing means on the stereoscopic picture can be made to be easily looked at.

Moreover, according to the stereoscopic picture displaying apparatus of another aspect of the present invention, controlling means controls display means to display a character so as to have a parallax in accordance with the amount of a parallax at a position at which the character is input on a screen when the character is input at a prescribed position on a stereoscopic picture with character-inputting means. Consequently, the character displayed on the stereoscopic picture can be made to be easily looked at.

Moreover, according to the stereoscopic picture displaying apparatus of a further aspect of the present invention, controlling means controls display means to display a frame body, which has a parallax, around a stereoscopic picture including a picture for a right eye and a picture for a left eye when the picture for a right eye and the picture for a left eye are alternately displayed on the display means so as to have a parallax. Consequently, the stereoscopic picture can be made to be easily looked at.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a block diagram showing a whole configuration of a stereoscopic picture displaying system to which the present invention is applied;

FIG. 2 is a block diagram showing a configuration of a digital camera shown in FIG. 1;

FIG. 3 is a perspective view showing an adapter to be attached to a lens-barrel of the digital camera shown in FIG. 1;

FIG. 4 is a schematic plan view showing an optical system of the adapter shown in FIG. 3;

FIG. 5 is a view illustrating a picture taken into a charge coupled device (CCD) of the digital camera shown in FIG. 1 when the adapter is attached to the digital camera;

FIG. 6 is a block diagram of a controlling unit of the stereoscopic picture displaying system shown in FIG. 1 for controlling the display thereof to display a stereoscopic picture including a picture for a right eye and a picture for a left eye that is photographed with the digital camera and for editing the data of the stereoscopic picture;

FIG. 7 is a block diagram showing a configuration of the controlling unit for a pair of shutter spectacles shown in FIG. 1;

FIGS. 8A to 8C are timing charts for illustrating the switching timing of a shutter section for a right eye and a shutter section for a left eye of the shutter spectacles shown in FIG. 1 when a stereoscopic picture is displayed in conformity with a progressive scanning system;

FIG. 9A is a schematic front view showing the display shown in FIG. 1 for illustrating the display of a stereoscopic picture displayed in conformity with an interlace scanning system;

FIGS. 9B to 9D are timing charts for illustrating the switching timing of the shutter section for a right eye and the shutter section for a left eye of the shutter spectacles shown in FIG. 1 when a stereoscopic picture is displayed in conformity with the interlace scanning system;

FIG. 10 is a flow chart for illustrating an edit processing of picture data in the stereoscopic picture displaying system shown in FIG. 1;

FIGS. 11A to 11D are vies of displayed pictures at each step of the edit processing shown in FIG. 10;

FIG. 12 is a flow chart for illustrating the preview mode at the step S8 of the edit processing shown in FIG. 10;

FIGS. 13A to 13C are views for illustrating display forms of pictures in the preview mode;

FIGS. 14A and 14B are views for illustrating a displayed picture on a displaying screen of the display shown in FIG. 1 in the preview mode;

FIG. 15 is a view for illustrating a pointer and a character on the displaying screen of the display in the preview mode;

FIG. 16 is a view for illustrating a method for displaying a stereoscopic frame around a stereoscopic picture adopted in the edit processing shown in FIG. 10;

FIG. 17 is a view for illustrating a storing format of picture data adopted in the edit processing shown in FIG. 10;

FIG. 18 is a view for illustrating another storing format of picture data adopted in the edit processing shown in FIG. 10;

FIG. 19 is a view for illustrating further storing format of picture data adopted in the edit processing shown in FIG. 10;

FIG. 20 is a flow chart showing the processes of activating a browsing software used in the edit processing shown in FIG. 10;

FIG. 21 is a view showing an activation screen of the browsing software;

FIG. 22 is a view showing a state that a picture is displayed by the browsing software;

FIG. 23 is a flow chart showing the processes of closing the browsing software;

FIGS. 24A and 24B are views illustrating of signal waveforms of the activation screen and the ending screen of the browsing software, respectively;

FIG. 25 is a view showing a state that a stereoscopic picture displayed on a screen of the browsing software is moved;

FIG. 26 is flow chart showing the processes of moving the stereoscopic picture displayed on the screen of the browsing software;

FIG. 27 is a view showing a state that a stereoscopic picture displayed on the screen of the browsing software is enlarged or reduced;

FIG. 28 is a flow chart showing the processes of enlarging or reducing the stereoscopic picture displayed on the screen of the browsing software;

FIG. 29 is a schematic block diagram showing a network system using the stereoscopic picture displaying system shown in FIG. 1; and

FIG. 30 is a flow chart showing the processes of accessing a home page in the network system shown in FIG. 29.

### DESCRIPTION OF THE PREFERRED EMBODIMENTS

Hereinafter, a stereoscopic picture displaying system to which the present invention is applied will be described by reference to the attached drawings.

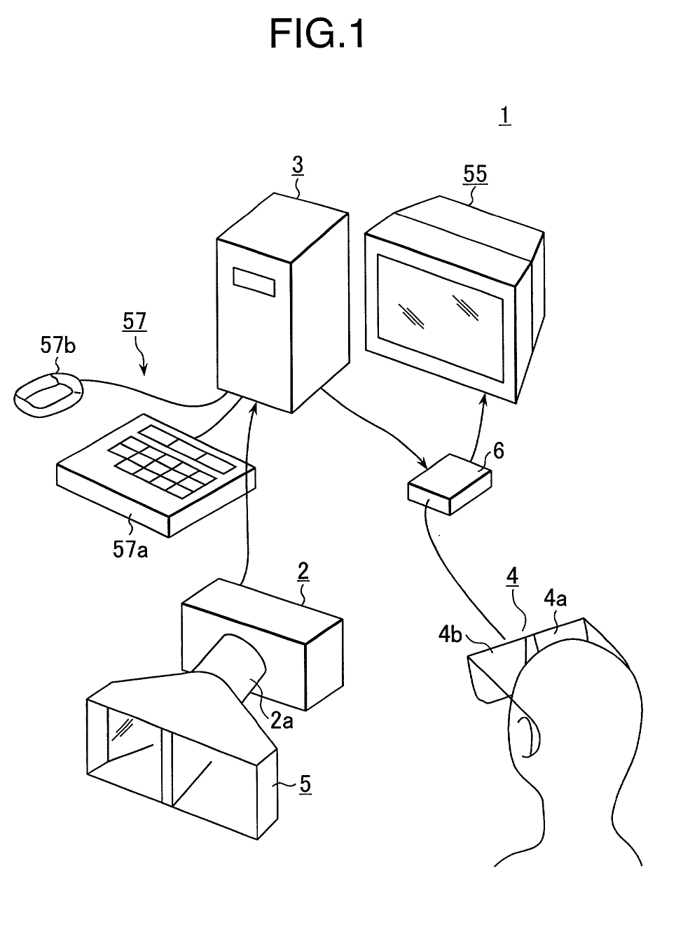

As shown in FIG. 1, a stereoscopic picture displaying system 1 to which the present invention is applied is composed of a digital camera 2 for photographing a picture, a controlling unit 3 for taking in picture data generated by the digital camera 2 to perform a data processing of the picture data taken for displaying a picture having a parallax on a display 55, and a pair of shutter spectacles 4 that blinds in turn an eye of an user synchronously with the pictures displayed on the display 55. Moreover, an adapter 5 for taking in a picture for a right eye and a picture for a left eye is attached to a lens-barrel 2a, in which an imaging lens, a focusing lens, a zoom lens and other lenses are assembled, of the digital camera 2. Thereby, a picture for a right eye and a picture for a left eye are taken in by one CCD element used in the digital camera 2. Then, the data of a picture including a picture for a right eye and a picture for a left eye that are generated by the digital camera 2 are supplied to the controlling unit 3. The controlling unit 3 picks up, for example, a picture for a right eye and a picture for a left eye on the basis of an input signal from an input unit 57 composed of a keyboard 57a as a character-inputting means, a mouse 57b as a position-inputting means for operating a pointing position of a pointing means such as a pointer, and other inputting devices. Then, the controlling unit 3 alternately displays the picked up picture for a right eye and the picked up picture for a left eye on the displays 55 such as a cathode-ray tube (CRT), a liquid crystal display panel or the like. Moreover, a controlling unit for spectacles 6 for controlling the turning on and off of the shutter spectacles 4 is provided between the controlling unit 3 and the display 55. The shutter spectacles 4 have a shutter section for the right eye 4a and a shutter section for the left eye 4b, and the shutter section for the right eye 4a and the shutter section for the left eye 4b are composed by a liquid crystal shutter. Such shutter spectacles 4 are connected with the control unit for spectacles 6. The shutter spectacles 4 make open and shut the liquid crystal shutter that composes the shutter section 4a and the shutter section 4b synchronously with the switching of the picture for a right eye and the picture for a left eye that are alternately displayed on the display 55 by the control of the controlling unit for spectacles 6. Thereby, the user can stereoscopically look at a picture displayed on the display 55 by opening and shutting the shutter sections 4a and 4b of the shutter spectacles 4 synchronously with the switching of the picked up picture for a right eye and the picked up picture for a left eye that are alternately displayed on the display 55.

Hereinafter, the digital camera 2, the controlling unit 3, the adapter 5 and the controlling unit for spectacles 6, all constituting the aforesaid stereoscopic picture displaying system 1, will be described by reference to the drawings.

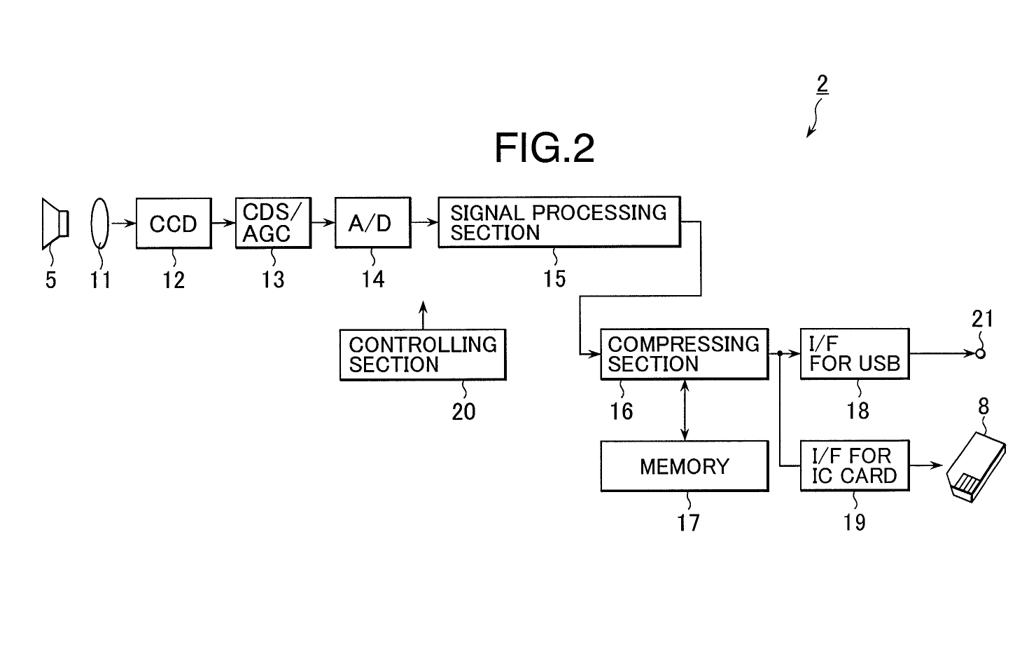

The digital camera 2 has a structure similar to an ordinary digital still camera. As shown in FIG. 2, the digital camera 2 comprises a CCD element 12 for performing the photoelectric conversion of an incoming light input from an imaging lens 11 to generate an image signal, a correlated double sampling/automatic gain control (CDS/AGC) 13 for eliminating noises of the image signal from the CCD element 12, an A/D converter 14 for converting the image signal output from the CDS/AGC 13 into a digital signal, and a signal processing section 15 for performing signal processing corresponding to color coding.

The CCD element 12 as an image sensor is a two-dimensional color image sensor having several million pixels, and the CCD element 12 converts imaged light into an image signal processed by color coding with a color coding filter of primary colors (Red, Green, Blue) or complementary colors (Yellow, Cyan, Magenta), and outputs the processed image signal to the CDS/AGC 13.

The CDS/AGC 13 performs the correlated double sampling and holding of the image signal supplied from the CCD element 12, and performs the removal of reset noises and the gain control of the processed image signal to output it to the A/D converter 14.

The A/D converter 14 converts the image signal from the CDS/AGC 13 into a picture data in a digital system. Then, the A/D converter 14 outputs the picture data that is converted into digital data to the signal processing section 15.

The signal processing section 15 performs a decoding processing and other processing corresponding to the color coding with the color coding filter of the CCD element 12 of the picture data output from the A/D converter 14 to produce brightness information, color difference information and other information from the picture data.

Furthermore, the digital camera 2 also comprises, as shown in FIG. 2, a compressing section 16 for compressing the picture data processed by the signal processing section 15, a memory 17 for storing the picture data compressed by the compressing section 16, an interface for Universal Serial Bus (USB) 18 for transmitting the picture data compressed by the compressing section 16 to the controlling unit 3, an interface for an IC card 19 for transmitting the picture data to an IC card 8 that uses a flash memory and other semiconductor memories as storage medium, and a controlling section 20 for controlling the whole of the digital camera 2. The picture data is derived from an output terminal 21.

The compressing section 16 compresses the picture data processed by the signal processing section 15 in a, for example, Joint Photographic Experts Group (JPEG) form. Then, the compressing section 16 outputs the picture data compressed in the JPEG format to the memory 17, and the picture data compressed in the JPEG format is stored in the memory 17.

Moreover, the interface for USB 18 transfers, for example, the picture data compressed in the JPEG format and stored in the memory 17 to the controlling unit 3 by way of the output terminal 21. Besides, the interface for an IC card 19 transfers, for example, the picture data compressed in the JPEG format and stored in the memory 17 to the IC card 8 used as an external storage unit.

The controlling section 20 controls the whole of the digital camera 2. To put it concretely, the controlling section 20 performs the driving and the controlling of the focusing lens, the zoom lens and other equipment on the basis of an operation signal from an operation section (not shown). Moreover, the controlling section 20 makes the memory 17 store the picture data compressed in the JPEG format. Furthermore, the controlling section 20 also directly transfers the compressed picture data to the controlling unit 3 through the interface for USB 18, or makes the IC card 8 store the compressed picture data through the interface for IC card 19 without storing the compressed picture data in the memory 17.

When an image is photographed with the digital camera 2 and the data of the photographed image is stored in the memory 17 of the digital camera 2, the incoming light input from the imaging lens 11 is converted into electric current as an image signal by the CCD element 12, and the generated image signal is converted into a digital signal by the A/D converter 14 through the CDS/AGC 13 to generate a picture data. The generated picture data is processed by the signal processing section 15, and the processed picture data is compressed in the JPEG format by the compressing section 16. Then, the compressed picture data is stored in the memory 17. Moreover, when the picture data in the JPEG format that is stored in the memory 17 is stored in the IC card 8, the controlling section 20 stores the picture data in the IC card 8 mounted on the digital camera 2 through the interface for IC card 19 on the basis of an operation signal from the operation section. Or, when the picture data is transferred to the controlling unit 3 through the interface for USB 18, the controlling section 20 transfers the picture data to the controlling unit 3 through the interface for USB 18 a n the output terminal 21 in response to an operation signal from the operation section.

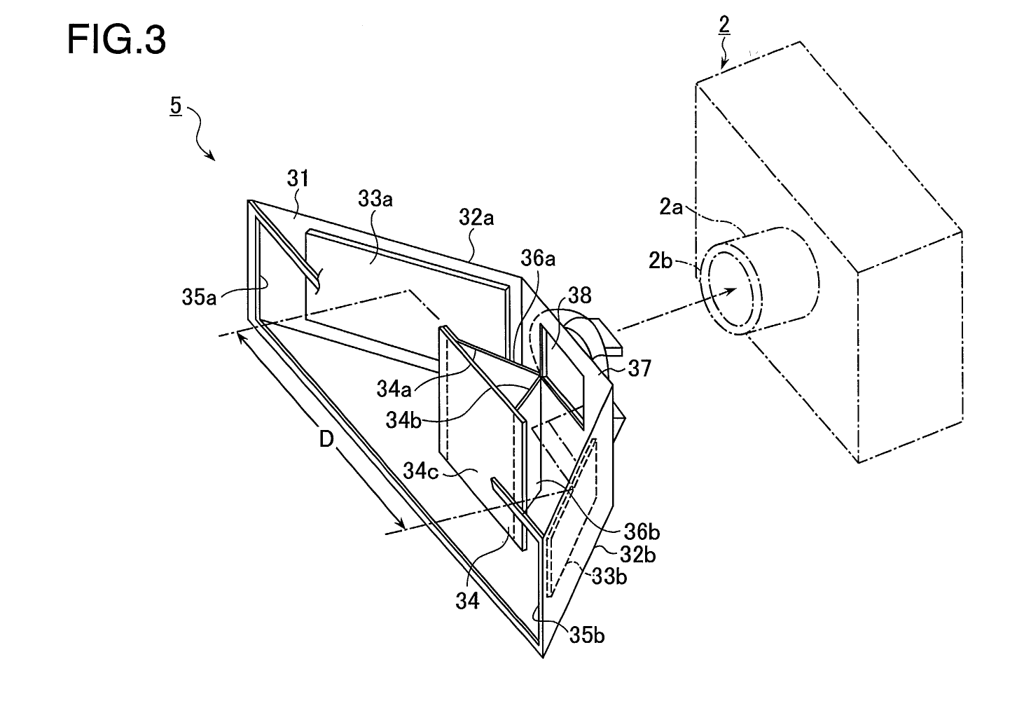

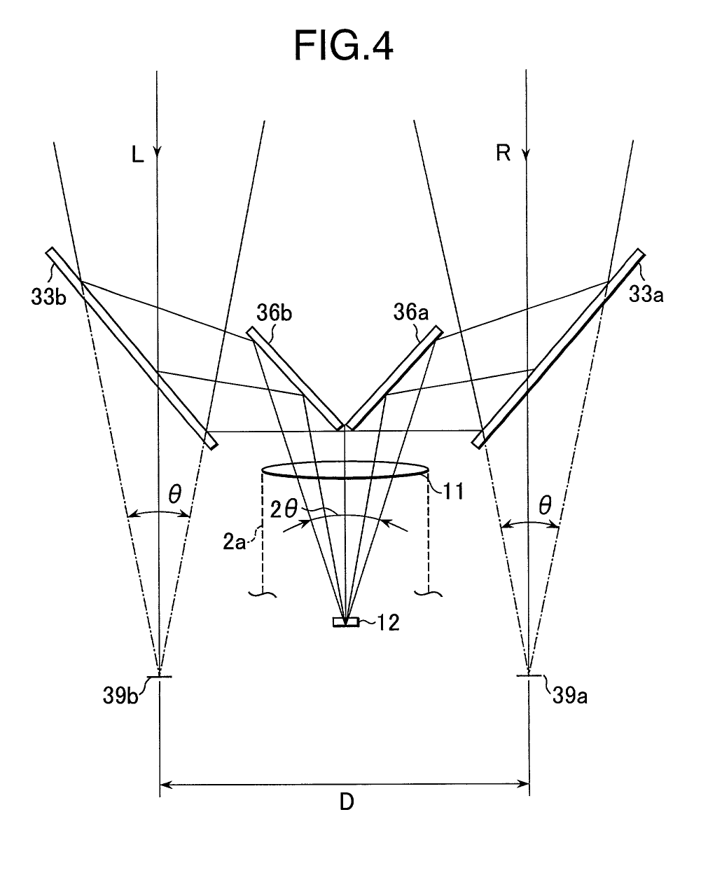

By the way, as shown in FIG. 1, the adapter 5 to take in a picture for a right eye and a picture for a left eye is attached to the lens-barrel 2a of the digital camera 2. The adapter 5 is for taking the picture for a right eye and the picture for a left eye in a right side area and in a left side area of the areas divided at about the center of the CCD element 12 used in the digital camera 2. In the adapter 5, as shown in FIGS. 3 and 4, first mirrors 33a and 33b are provided on inner walls of inclined walls 32a and 32b on both of the left side and the right side that are side walls of an outer housing 31. Moreover, a partition wall 34 forming a triangle pole is fixed at about the center of the outer housing 31. A side face 34c of the partition wall 34 faces to the front surface of the outer housing 31, and forms an opening section for a right eye 35a and an opening section for a left eye 35b for taking in the external light together with the outer housing 31. Moreover, two side faces 34a and 34b, both adjoining the side face 34c, are fixed so as to be substantially in parallel with the inclined walls 32a and 32b of the outer housing 31, respectively, and second flat mirrors 36a and 36b are provided on the two side faces 34a and 34b, respectively, so as to be opposed to the first flat mirrors 33a and 33b, respectively. Moreover, an opening part 38 for taking the external light that reflected by the first flat mirrors 33a and 33b and the second flat mirrors 36a and 36b into the lens-barrel 2a of the digital camera 2 is formed on the back surface wall 37 of the outer housing 31.

The thus structured adapter 5 is fixed to the front end of the lens-barrel 2a so that the opening part 38 is opposed to the imaging lens 11 of the digital camera 2. Then, the external light R taken in through the opening section for the right eye 35a and the external light L taken in through the opening section for the left eye 35b are reflected by the first flat mirrors 33a and 33b, respectively, and are reflected by the second flat mirrors 36a and 36b, respectively. Then, the reflected external light R and the reflected external light L are taken into the CCD element 12 of the digital camera 2 through the imaging lens 11 opposed to the opening part 38. Here, as shown in FIG. 4, when angles of a view at points 39a and 39b are supposed to be ?, a picture having angle of a view of 2? is taken into the CCD element 12. Moreover, because a distance D between the points 39a and 39b determines a parallax, the distance D is set to be 65 mm to 70 mm in accordance with an average distance of human eyes. Incidentally, the distance D may be adjustable according to the differences among individuals. Consequently, the picture for a right eye and the picture for a left eye that are distant from each other by the pupil distance are taken into the CCD element 12 so that they are located side by side on the surface of the CCD element 12.

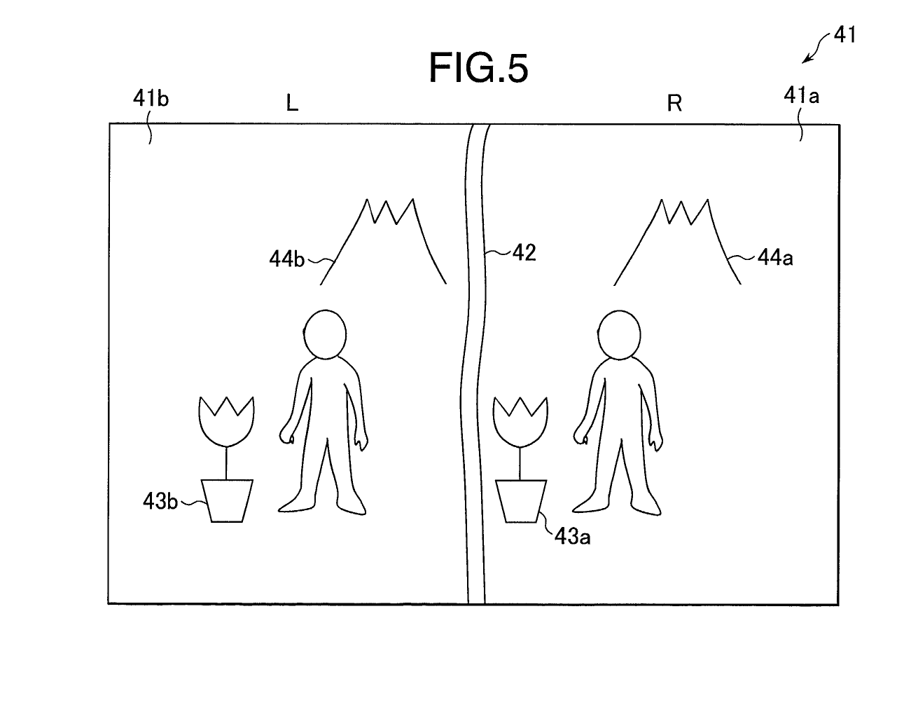

Now, FIG. 5 shows a picture taken into the CCD element 12 when the adapter 5 is fixed to the digital camera 2. A picture 41 includes a woman standing by a flower planted in a flowerpot and a mountain located as a background. As shown in FIG. 5, in the picture 41, a picture for a right eye 41a is photographed in the substantially right half of the picture 41 and a picture for a left eye 41b is photographed in the substantially left half of the picture 41, both of the halves being divided by a boundary part 42. When the picture for a right eye 41a and the picture for a left eye 41b are compared, for example, the flower 43a and the mountain 44a in the picture for a right eye 41a are slightly shifted to the left side in comparison with the flower 43b and the mountain 44b in the picture for a left eye 41b. In such a way, the picture for a right eye 41a and the picture for a left eye 41b are shifted by the parallax on the right and left sides, namely both the pictures are shifted by the distance D. Incidentally, the boundary part 42 is actually formed as a blurred white line.

Consequently, when photographing is performed with the digital camera 2 to which the adapter 5 is attached, the picture 41 composed of the picture for a right eye 41a and the picture for a left eye 41b is taken into the CCD element 12, and the picture data including the data of each of the picture 41 as one unit is stored in the memory 17 and the IC card 8, and further the picture data is transferred to the controlling unit 3 through the interface for USB 18. By using such adapter 5, the digital camera 2 can compose the picture 41 for a stereoscopic picture as one file, and then can facilitate the management thereof. Moreover, because it becomes unnecessary to prepare a timing generator to take the synchronization of each camera like in the conventional case where two cameras are used, the simplification of the configuration can be attained. Moreover, the digital camera 2 to which the adapter 5 is attached can simultaneously photograph the right side picture and the left side picture without using two cameras when static images are continuously photographed to be made as a dynamic image. Moreover, because the digital camera 2 to which the adapter 5 is attached is not necessary to adjust optical axes of two cameras, a zooming function using a zoom lens can also be used.

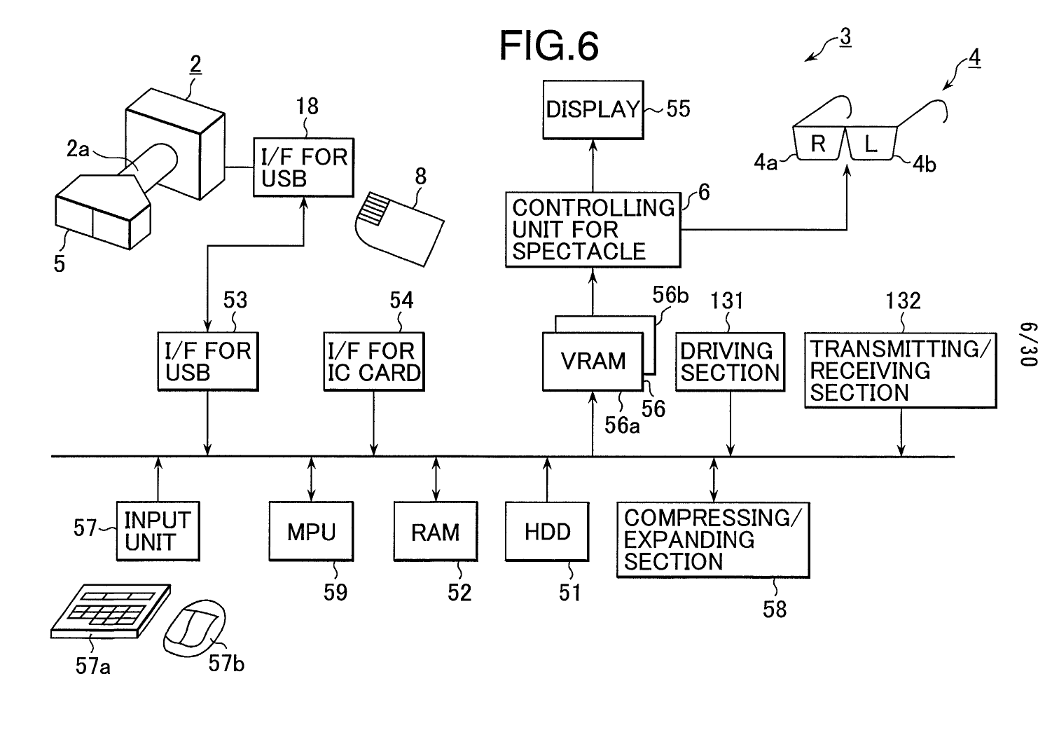

Next, the controlling unit 3 for editing and displaying the picture data generated by the digital camera 2 to which the adapter 5 is attached, namely the picture data of the picture 41 composed of the picture for a right eye 41a and the picture for a left eye 41b, will be described by reference to FIG. 6.

The controlling unit 3 has substantially the same configuration as that of an ordinary personal computer. The controlling unit 3 comprises a hard disk drive (hereinafter, also referred to as HDD) 51 for storing the aforesaid picture data of the picture 41, an application program for editing the picture data, an application program for stereoscopically displaying the picture 41, and other data and programs, a random access memory (hereinafter, also referred to as RAM) 52 for accepting temporarily the application program and other data and programs stored in the HDD 51, an interface for USB 53 for performing the data transmission with the aforesaid digital camera 2, an interface for an IC card 54 for reading out the data stored in the IC card 8, the display 55 for displaying a picture, a video random access memory (hereinafter, also referred to as VRAM) 56 for making a picture be displayed on the display 55, the input unit 57 composed of the keyboard 57a and the mouse 57b for inputting a command for making an application program be executed, a compressing/expanding section 58 for expanding data of the JPEG format and compressing data in the JPEG format, and a microprocessor unit (hereinafter, also referred to as MPU) 59 for controlling the whole of the controlling unit 3.

In the HDD 51, there are stored an operating system (hereinafter, also referred to as OS), an editing program for editing the picture 41 composed of the picture for a right eye 41a and the picture for a left eye 41b, a browsing software for browsing the picture edited by the editing program, the picture data of the picture 41 composed of the picture for a right eye 41a and the picture for a left eye 41b, and other data and programs.

The RAM 52 accepts an application program to be executed and data of a picture to be processed from the HDD 51 and other units. For example, the picking up processing of the picture data of the picture 41 for picking up the picture data of a picture for a right eye and the picture data of a picture for a left eye from the unit picture data of the picture 41 composed of the picture for a right eye 41a and the picture for a left eye 41b for the displaying of them on the display 55 is executed at the RAM 52.

The interface for USB 53 receives the picture data compressed in the JPEG format by the digital camera 2 when the interface for USB 53 is connected with the interface for USB 18 of the digital camera 2 with an USB format. Then, the picture data received by the interface for USB 53 is stored in the HDD 51 by the MPU 59.

The interface for an IC card 54 reads out the picture data, which is stored in the IC card 8, of a picture photographed by, for example, the digital camera 2 when the IC card 8 is loaded on the drive for the IC card 8 that is formed in the main body of the controlling unit 3. Then, the picture data read out by the interface for USB 53 is stored in the HDD 51 by the MPU 59.

The display 55 is constituted of a CRT or a liquid crystal display panel, and the display 55 displays the picture 41 composed of the picture for a right eye 41a and the picture for a left eye 41b located side by side in the horizontal direction as shown in FIG. 5 before the edit processing is performed. Moreover, the display 55 displays a picked up picture for a right eye and a picked up picture for a left eye alternately with a parallax on the basis of the picked up picture data for a right eye and the picked up picture data for a left eye, both having been processed by the picking up processing of the picture data of the picture for a right eye 41a and the picture for a left eye 41b. Incidentally, the display 55 may be either of one performing its displaying in conformity with the progressive scanning system or one performing its displaying in conformity with the interlace scanning system.

The VRAM 56 for displaying an picture on the display 55 has memory sections 56a and 56b, each having a capacity necessary for storing picked up picture data of one frame. For example, the picked up picture data for a right eye of one frame is stored in the memory section 56a, and the picked up picture data for a left eye of one frame is stored in the memory section 56b. Then, the VRAM 56 alternately outputs the picked up picture data for a right eye stored in the memory section 56a and the picked up picture data for a left eye stored in the memory section 56b to the display 55.

When the picture data stored in, for example, the IC card 8 and compressed in the JPEG format is read out to the RAM 52, the compressing/expanding section 58 expands the compressed picture data. Moreover, when edited picture data is preserved, the compressing/expanding section 58 compresses the picture data in the RAM 56 into the JPEG format and stores it in the HDD 51 or in the IC card 8.

The MPU 59 controls the whole of the controlling unit 3. For example, the MPU 59 stores picture data that is read out by the interface for USB 53 or by the interface for an IC card 54 into the HDD 51. Moreover, the MPU 59 reads out an editing program for editing the picture 41 composed of the picture for a right eye 41a and the picture for a left eye 41b, a browsing software for browsing the picture edited by the editing program, and picture data to be processed by these programs to the RAM 52 from the HDD 51. Then, the MPU 59 performs the picking up processing for picking up the picture data of a picture for a right eye and the picture data of a picture for a left eye for displaying on the display 55 from the unit picture data, and makes the RAM 52 output the processed picked up picture data for a right eye to the memory section 56a of the VRAM 56, and makes the RAM 52 output the processed picked up picture data for a left eye to the memory section 56b of the VRAM 56.

When the picked up pictures composed of the picked up picture for a right eye and the picked up picture for a left eye are displayed on the display 55, the controlling unit 3 described above operates as follows. That is, the MPU 59 expands the picture data composed of the picture data for a right eye and the picture data for a left eye that is compressed in the JPEG format and read out from the HDD 51 and other memories, and then the MPU 59 reads out the expanded picture data to the RAM 52. Then, the MPU 59 picks up prescribed regions of the picture for a right eye 41a and the picture for a left eye 41b shown in FIG. 5 on the basis of a command output from the input unit 7 operated by an user. The MPU 59 then outputs the picked up picture data for a right eye to the memory section 56a constituting the VRAM 56, and outputs the picked up picture data for a left eye to the memory section 56b constituting the VRAM 56. Next, the VRAM 56 alternately outputs the picked up picture data for a right eye from the memory section 56a and outputs the picked up picture data for a left eye from the memory section 56b. Here, each picked up picture data is output to the display 55 adopting the system in which all of the scan lines are sequentially drawn, i.e. the progressive scanning system. The picked up picture for a right eye and the picked up picture for a left eye are alternately displayed on the display 55 to enable an user wearing the shutter spectacles 4 to stereoscopically look at the picture displayed on the display 55.

Now, when the picture for a right eye and the picture for a left eye are displayed on the display 55 adopting the progressive scanning system, as shown in FIGS. 1 and 6, the picked up picture data for a right eye of one frame and the picked up picture data for a left eye of one frame are read out from the memory sections 56a and 56b of the VRAM 56, and the picked up picture for a right eye and the picked up picture for a left eye are displayed alternately. It is necessary for the shutter spectacles 4 to switch the shutters of the shutter section for a right eye 4a and the shutter section for a left eye 4b synchronously with the switching of the display of the picked up picture for a right eye and the picked up picture for a left eye. Accordingly, the controlling unit for spectacles 6 for controlling the shutter spectacles 4 is provided between the display 55 and the VRAM 56.

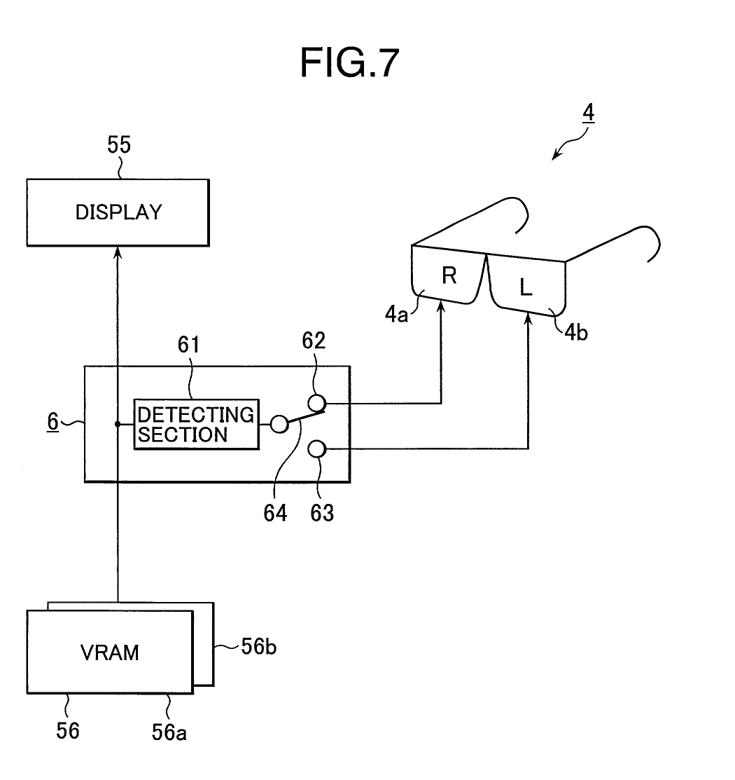

The controlling unit for spectacles 6 comprises, as shown in FIG. 7, a detecting section 61 for detecting the vertical synchronizing signal of each picture data when the picked up picture data for a right eye of one frame and the picked up picture data for a left eye of one frame that are stored in the memory sections 56a and 56b of the VRAM 56, respectively, are output to the display 55, and a switch 64 the center contact of which is connected with the detecting section 61 and one of the switching contacts of which is connected with a terminal 62 of the shutter section for the right eye 4a of the shutter spectacles 4 and further the other switching contact of which is connected with the terminal 63 of the shutter section for the left eye 4b of the shutter spectacles 4.

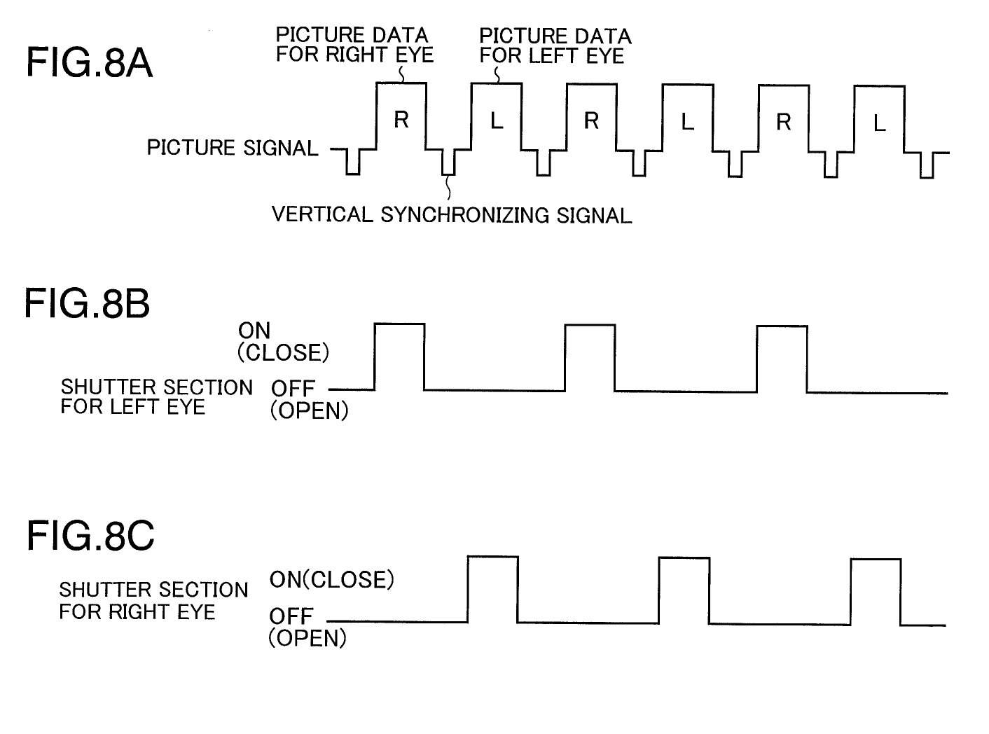

As shown in FIG. 8A, when the picked up picture data for a right eye and the picked up picture data for a left eye are alternately output from the VRAM 56 to the display 55, the detecting section 61 detects the vertical synchronizing signal of each picked up picture data. For example, when the picked up picture data for a right eye is output from the memory section 56a of the VRAM 56, the detecting section 61 detects the vertical synchronizing signal of the picked up picture data. Detecting the vertical synchronizing signal of the picked up picture data for a right eye, the detecting section 61 switches the switch 64 so as to turn off the shutter section for the left eye 4b of the shutter spectacles 4 as shown in FIG. 8B so that an user can observe the picked up picture for a left eye that is to be displayed subsequently with the left eye of the user, and so as to turn on the shutter section 4a for the right eye as shown in FIG. 8C. When a picked up picture for a left eye is displayed on the display 55, the shutter section for the left eye 4b takes thereby the open state and the shutter section for the right eye 4a takes the closing state.

Successively, when the detecting section 61 detects the vertical synchronization signal of the picked up picture data for a left eye that is now displayed, as shown in FIG. 8C, the detecting section 61 switches the switch 64 so as to turn off the shutter section for the right eye 4a of the shutter spectacles 4 for enabling the user to observe the picked up picture for a right eye that is to be displayed subsequently with the right eye of the user, and, as shown in FIG. 8B, so as to turn on the shutter section for left eye 4b. Consequently, when the picked up picture for a right eye is displayed on the display 55, the shutter section for the right eye 4a takes a open state and the shutter section for the left eyes takes a closing state. Hereafter, the switching of the shutters of the shutter section for the right eye 4a and the shutter section for the left eye 4b of the shutter spectacles 4 is performed synchronously with the timing of the switching of the picked up picture for a right eye and the picked up picture for a left eye, and consequently the user can observe the pictures displayed on the display 55 stereoscopically.

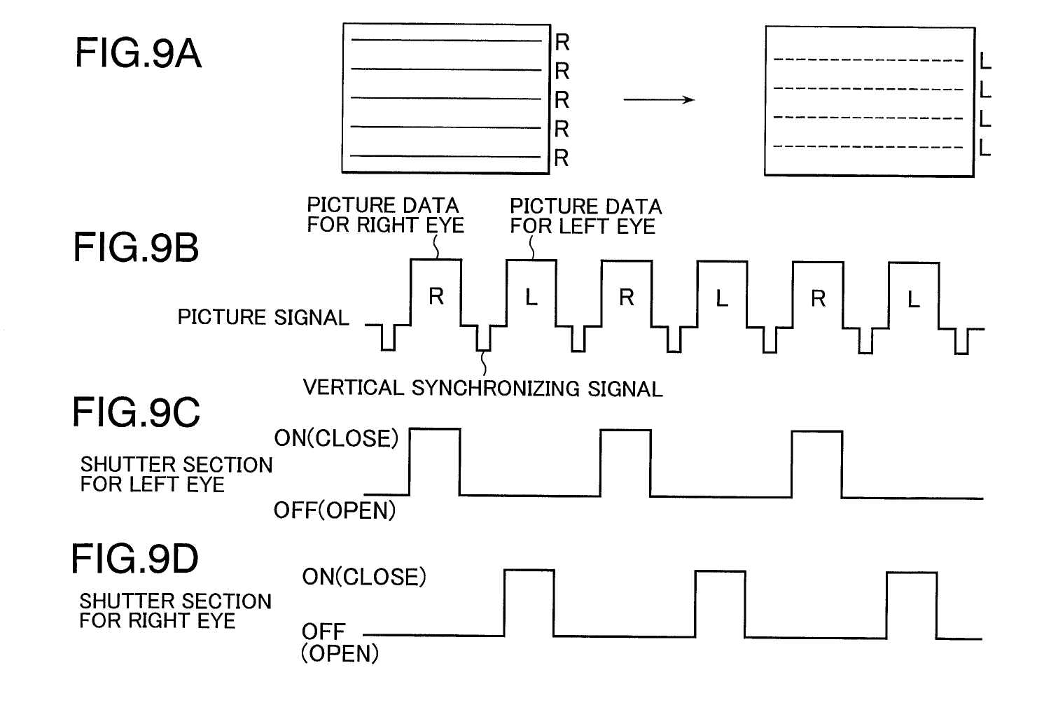

In the case where the display 55 displaying pictures in conformity with the interlace scanning system is used will next be described. In the aforesaid memory 56a of the VRAM 56, the horizontal scan line data of the picked up picture for a right eye are stored by one line, for example, the picked up picture data for a right eye formed by the thinning out of the even line data from the whole of the picked up picture data for a right eye of one frame are stored. Similarly, in the aforesaid memory 56b of the VRAM 56, the horizontal scan line data of the picked up picture for a left eye are stored by one line, for example, the picked up picture data for a left eye formed by the thinning out of the odd line data from the whole of the data of the picked up picture data for a left eye of one frame are stored. Then, the thinned out picked up picture data for a right eye is output from the memory 56a to the display 55 as the picture data of one field, and the thinned out picked up picture data for a left eye is output from the memory 56b to the display 55 as the picture data of the next field. Consequently, the picture formed by the thinning out of even lines is first displayed on the display 55, and then the picture formed by the thinning out of odd lines is next displayed on the display 55 as shown in FIG. 9A.

At this time, the controlling unit for spectacles 6 controls the shutter spectacles 4 as follows. That is, as shown in FIG. 9B, when the picked up picture data for a right eye for the first field is output from the memory 56a, the detecting section 61 detects the vertical synchronizing signal located at the end of the field. Detecting the vertical synchronizing signal of the picked up picture data for a right eye, the detecting section 61 switches the switch 64 so that the shutter section for the left eye 4b of the shutter spectacles 4 is turned off for enabling an user to observe the picked up picture for a left eye that is to be displayed subsequently with the left eye of the user as shown in FIG. 9C and the shutter section for the right eye 4a is turned on as shown in FIG. 9D. When a picked up picture for a left eye is displayed on the display 55, the shutter section for the left eye 4b consequently takes a state of open and the shutter section for the right eye 4a takes a state of closing.

Next, when the detecting section 61 detects the vertical synchronization signal of the picked up picture data for a left eye that is now displayed as shown in FIG. 9B, the detecting section 61 switches the switch 64 so that the shutter section for the right eye 4a of the shutter spectacles 4 is turned off for enabling the user to observe the picked up picture for a right eye to be displayed next with the right eye of the user as shown in FIG. 9D and the shutter section for the left eye 4b is turned on as shown in FIG. 9C. When a picked up picture for a right eye is displayed on the display 55, the shutter section for the right eye 4a consequently takes the state of open and the shutter section for the left eye 4b takes the state of closing. Hereafter, the switching of the shutters of the shutter section for the right eye 4a and the shutter section for the left eye 4b of the shutter spectacles 4 is thus performed synchronously with the timing of the switching of the picked up picture for a right eye and the picked up picture for a left eye, and consequently an user can observe the pictures displayed on the display 55 stereoscopically.

Incidentally, in the case where the progressive scanning system is adopted, the picked up picture data for a right eye formed by the thinning out of, for example, even lines may be stored in the memory section 56a and the picked up picture data for a left eye formed by the thinning out of odd lines may be stored in the memory section 56b as described above. In this case, similarly to in the interlace scanning system, a picked up picture for a right eye formed by the thinning out of even lines and a picked up picture formed by the thinning out of odd lines are alternately displayed on the display 55. Incidentally, when the picked up picture data for a right eye and the picked up picture data for a left eye, horizontal lines of both pictures being thinned out, are output to the VRAM 56, because a CCD element having several millions of pixels is used as the CCD element 12 of the digital camera 2 as described above, the user does not feel the deterioration of the picture quality of the displayed pictures.

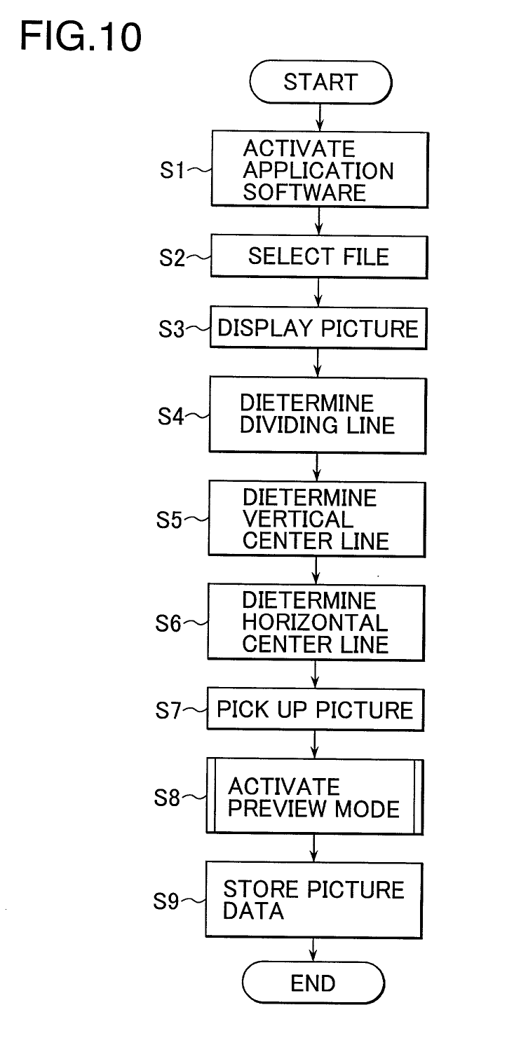

Next, the processing using the aforesaid controlling unit 3 of the picture data of a picture photographed by the aforesaid digital camera 2 with the attached adapter 5, namely the edit processing of the picture data will be described by reference to FIG. 10.

At first, at step S1, when an icon for activating the editing program displayed on the display 55 is clicked with the mouse 57b for example, the MPU 59 reads out the editing program from the HDD 51 to the RAM 52 for activating it, and the edit processing advances to step S2.

In the step S2, the MPU 59 selects a file of the picture data to be edited on the basis of a command from the input unit 57 composed of the keyboard 57a and the mouse 57b, and opens the selected files. Here, the picture data constitutes a file compressed in the JPEG format. To put it concretely, the MPU 59 reads out the corresponding file from the memory 17 of the digital camera 2 to the RAM 52 after expanding the file with the compressing/expanding section 58 when the digital camera 2 and the controlling unit 3 are connected with each other with an USB interface. Moreover, when the IC card 8 is mounted on the drive of the controlling unit 3, the MPU 59 reads out the corresponding file from the IC card 8 to the RAM 52 after expanding the file by the compressing/expanding section 58. And when the corresponding file is stored in the HDD 51, the MPU 59 reads out the file from the HDD 51 to the RAM 58 after expanding it by the compressing/expanding section 58. And then the edit processing advances to step S3.

At the step S3, the MPU 59 outputs the read out picture data stored in the RAM 52 temporarily to the display 55 adopting the progressive scanning system or the interlace scanning system through the VRAM 56 to make the display 55 displays a picture based on the picture data. And then, the edit processing advances to step S4. At the step S3, the picture 41 shown in the aforesaid FIG. 5 is displayed on the display 55. That is, the picture for a right eye 41a and the picture for a left eye 41b are displayed as one picture 41 on the display 55 abreast in the horizontal direction. And, the picture for a right eye 41a and the picture for a left eye 41b are shifted by the parallax on the right side and the left side. Incidentally, the boundary part 42 between the picture for a right eye 41a and the picture for a left eye 41b is displayed as the rather blurred white line.

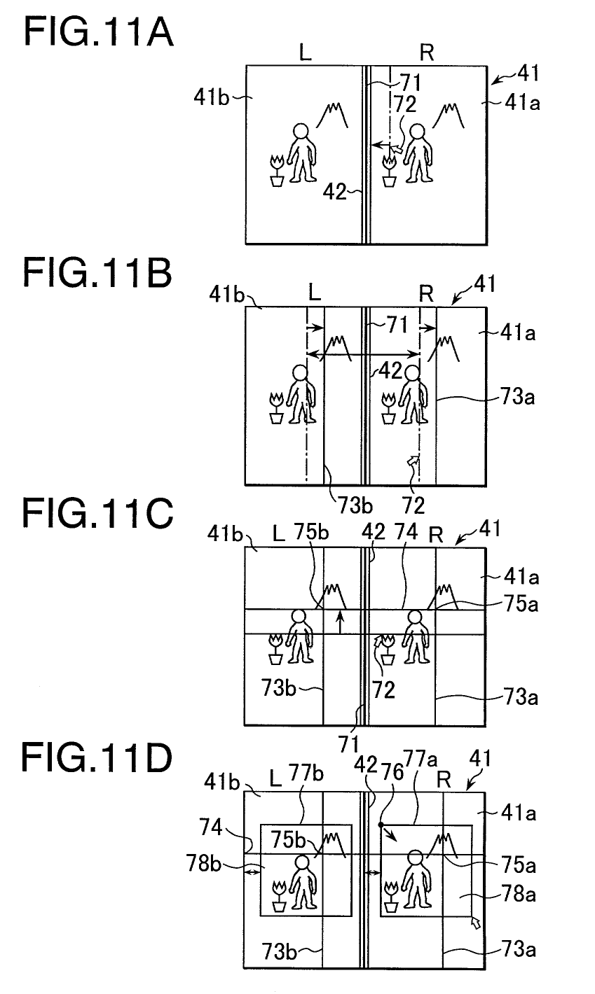

At the step S4, the MPU 59 displays a division line 71 to divide the picture 41 into the picture for a right eye 41a and the picture for a left eye 41b in the vertical direction of the display 55 as shown in FIG. 11A. Then, the division line 71 is held by the pointer 72 when the mouse 57b is clicked, and is moved to overlap on the boundary part 42 of the picture 41 by an user watching it. The MPU 59 thereby divides the picture 41 into the picture for a right eye 41a and the picture for a left eye 41b. Consequently, the user can discern the picture for a right eye 41a and the picture for a left eye 41b easily.

At step S5, the MPU 59 makes the display 55 display a vertical center line 73a for the picture for a right eye 41a and a vertical center line 73b for the picture for a left eye 41b as shown in FIG. 11B for making the horizontal centers of the picture for a right eye 41a and the picture for a left eye 41b divided at the division line 71 displayed on the display 55 easily looked at. Here, the MPU 59 makes the display 55 display the vertical center line 73a for the picture for a right eye 41a and the vertical centerline 73b for the picture for a left eye 41b so that they are at the same distance from the division line 71. Then, the vertical center line 73a for the picture for a right eye 41a is held by the pointer 72 when the mouse 57b is clicked, and is moved to a horizontal center position that is desired by the user in the horizontal direction by the user watching it. At the same time, the vertical center line 73b for the picture for a left eye 41b is automatically moved to the same direction as that of the movement of the vertical center line 73a for the picture for a right eye 41a by the same quantity of movement as that of the center line 73a. Thus the MPU 59 makes it easy for the user to look at the horizontal center of the picture for a right eye 41a and the horizontal center of the picture for a left eye 41b so that the set vertical center lines 73a and 73b can be guideposts for picking up operation of the picture for a right eye 41a and the picture for a left eye 41b at the nest step.

At step S6, the MPU 59 makes the display 55 display a horizontal center line 74 for makes it easy to look at the center in the vertical direction of the picture for a right eye 41a and the picture for a left eye 41b divided at the division line 71 displayed on the display 55 as shown in FIG. 1C. Here, the MPU 59 makes the display 55 display the horizontal center line 74 over the picture for a right eye 41a and the picture for a left eye 41b at the center in the vertical direction. Then, the horizontal center line 74 is held by the pointer 72 when the mouse 57b is clicked, and is vertically moved to a position that the user desires as the center in the vertical direction by the user while the user watches the horizontal center line 74 with eyes. The MPU 59 thereby makes it easy for the user to look at the vertical center of the picture for a right eye 41a and the picture for a left eye 41b, and further makes center points 75a and 75b of the picture for a right eye 41a and the picture for a left eye 41b, respectively, easy to determinate with the aforesaid center lines 73a and 73b, respectively, so that the center points 75a and 75b can be guideposts for picking up operation of the picture for a right eye 41a and the picture for a left eye 41b at the next step.

Incidentally, the center points 75a and 75b can also be readjusted. That is, the adjustment of the vertical center lines 73a and 73b can be performed by the re-displacement of the center line 73a for the picture for a right eye 41a in the horizontal direction as shown in FIG. 11B, and the adjustment of the horizontal center line 74 can be performed by the displacement of the horizontal center line 74 in the vertical direction as shown in FIG. 1C.

At step S7, the MPU 59 executes the picking up processing of a picture that the user desires. To put it concretely, when the user determines a starting point 76 in the picture for a right eye 41a with the pointer 72 of the mouse 57b by reference to the aforesaid vertical center line 73a, the horizontal center line 74 and the center point 75a, and when the user moves the pointer 72 in a diagonal direction, a substantially rectangular picked up line 77a is displayed in the picture for a right eye 41a as shown in FIG. 1D. At the same time, the MPU 59 makes the display 55 display a picked up line 77b having the same shape as the picked up line 77a in the picture for a left eye 41b, too. At this time, the MPU 59 makes the display 55 display the picked up line 77b so that the distance between the division line 71 and the line of the picked up line 77a on the side of the division line 71 becomes equal to the distance between the side edge of the picture for a left eye 41b on the side farther from the division line 71 and the line of the picked up line 77b on the side of the side edge.

Thus, the MPU 59 generates the picture data of the picked up picture for a right eye 78a and the picture data of the picked up picture for a left eye 78b for stereoscopically displaying a picture on the display 55. By the way, there is a case where the user wants to look at how the picture is displayed on the display 55 stereoscopically before the user stores the picture data of the thus actually picked up picture to the HDD 51. Accordingly, at step S8, the MPU 59 outputs the picture data of the picked up picture for a right eye 78a and the picture data of the picked up picture for a left eye 78b to the VRAM 56, and activates a preview mode. Incidentally, the preview mode will be described in detail later. Then, at step S9, the MPU 59 stores the picture data of the picture for a right eye 78a and the picture data of the picture of the left eye 78b in the HDD 51 after compressing them in the compressing/expanding section 58 in the JPEG format. Incidentally, the details of the storing method will also be described later.

In the aforesaid edit processing method of the picture data, a stereoscopic picture suitable for the user's taste can be displayed on the display 55 by picking up a region in the picture 41 that the use desires. Moreover, when the picture data of the picture 41 is edited, because the vertical center lines 73a and 73b and the horizontal center line 74 are displayed on the display 55, the user can easily perform the picking up operation of the picture 41.

Incidentally, because the editing operation of the picture 41 is performed by the use of the picture for a right eye 41a, only the picture for a right eye 41a for the editing operation may be displayed on the display 55 while the boundary part 42 is set to be automatically recognized by the MPU 59.

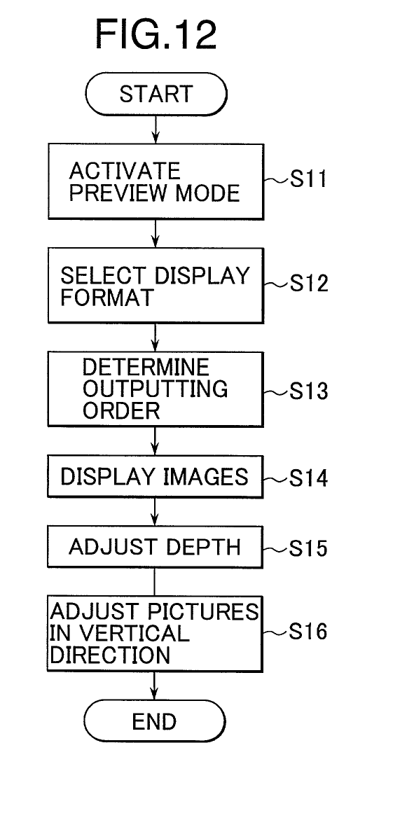

Next, the preview mode at the aforesaid step S8 will be described by reference to FIG. 12. At step S11, the MPU 59 activates the preview mode on the basis of a command from the input unit 57.

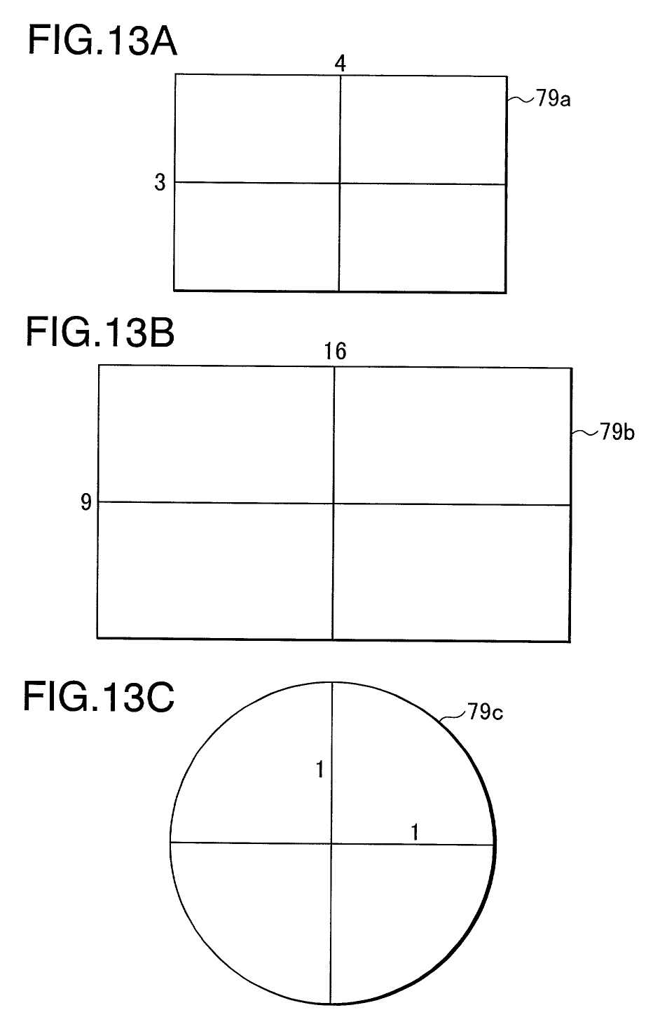

At step S12, the MPU 59 makes the display 55 display a selection screen of a display form. Now, there are following forms for the display of a stereoscopic picture: a substantially rectangular frame 79a having an aspect ratio of 3 to 4 as shown in FIG. 13A, a substantially rectangular frame 79b having an aspect ratio of 9 to 16 as shown in FIG. 13B, and a substantially circular frame 79c as shown in FIG. 13C. Then, the MPU 59 selects any one of the frames 79a-79c shown by FIGS. 13A to 13C, respectively, on the basis of a command from the input unit 57 generated by the operation of the user, and the preview mode advances to step S13.

At the step S13, the MPU 59 determines the outputting order of the picture data of the picked up picture for a right eye 78a and the picture data of the picked up picture for a left eye 78b from the VRAM 56 on the basis of an input signal from the input unit 57 by the operation of the user. To put it concretely, the outputting order indicates which picture of the picked up pictures for the right eye 78a and for the left eye 78b is first displayed on the display 55.

At step S14, the MPU 59 makes the display 55 display the picked up picture for a right eye 78a and the picked up picture for a left eye 78b alternately so as to have a parallax. To put it concretely, the MPU 59 outputs the picture data of the picked up picture for a right eye 78a to the memory section 56a of the VRAM 56, and outputs the picture date of the picked up picture for a left eye 78b to the memory section 56b of the VRAM 56. Then, the VRAM 56 alternately outputs the picture data of the picture for a right eye 78a and the picture data of the picture for a left eye 78b to the display 55 in conformity with the outputting order determined at the step S13 so that the display 55 displays the picked up picture for a right eye 78a and the picked up picture for a left eye 78b alternately.

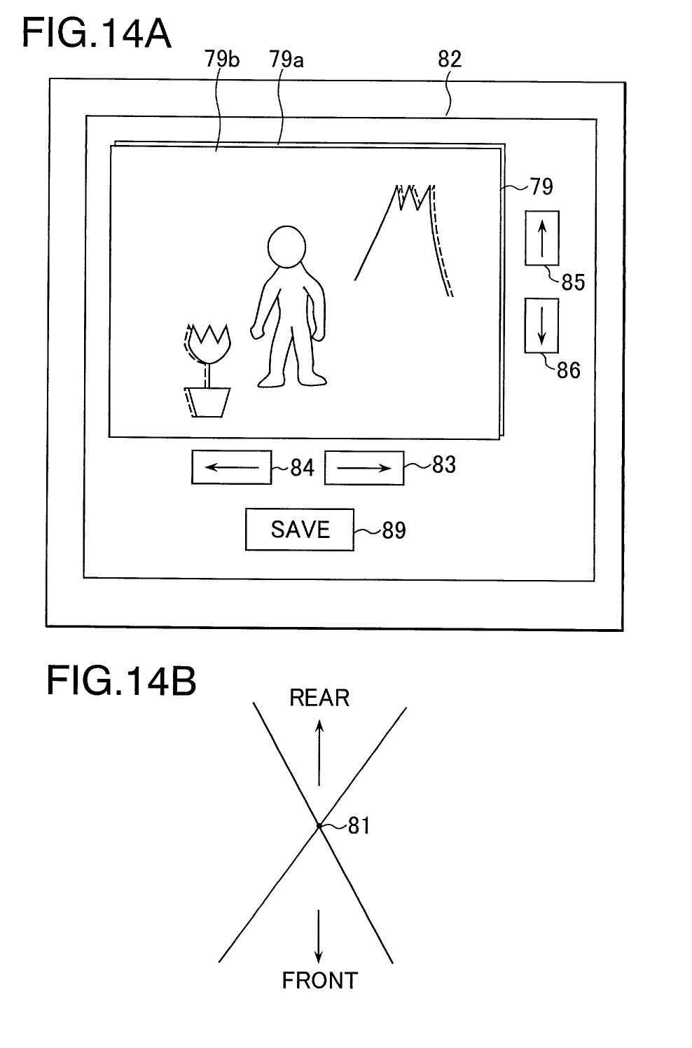

As a result, the picked up picture for a right eye 78a and the picked up picture for a left eye 78b are displayed on the display 55 as if they are shifted from each other as shown in FIGS. 14A and 14B. To put it concretely, the picked up picture for a right eye 78a and the picked up picture for a left eye 78b displayed on the display 55 are displayed so that the amount of shifting becomes zero at the position of the visual point of the user and the amount of the shifting becomes larger from the position of zero to the front direction or the rear direction viewed at the standpoint of the user. Incidentally, the position where the amount of shifting is zero is hereinafter referred to as a cross point 81. That is, if the position where a person is standing in FIG. 14A is supposed to the cross point 81, the mountain is displayed so as to shift to a direction because it is located at a rear place to the person's position, and the flower is displayed so as to shift to another direction because it is located at a front position to the person's position.

Moreover, as described above, the controlling unit for spectacles 6 performs the switching of the shutters of the shutter section for the right eye 4a and the shutter section for the left eye 4b in accordance with the outputting order of the picture data at the step S13. At the time of the switching, the controlling unit for spectacles 6 detects the vertical synchronization signals of the picture data of the picked up picture for a right eye 78a and the picture data of the picked up picture for a left eye 78b by the detecting section 61, and performs the switching of the shutters of the shutter section for the right eye 4a and the shutter section for the left eye 4b synchronously with the timing of switching of the picked up picture for a right eye 78a and the picked up picture for a left eye 78b displayed on the display 55. Thereby, the user can stereoscopically look at the picture displayed on the display 55. At the following steps, the user performs the preview mode processing in a state that the user wears the shutter spectacles 4.

At step S15, depth adjustment, i.e. the adjustment of the cross point 81, is performed for making it easiest for the user to look at the stereoscopic picture. That is, the MPU 59 makes the display 55 display adjustment buttons 83, 84 to adjust the cross point 81 on the screen 82 shown in FIG. 14A. Now, the adjustment button 83 is for moving the cross point 81 to the front direction on the screen 82, i.e. for moving it horizontally to one direction, and the adjustment button 84 is for moving the cross point 81 to the rear direction, i.e. for moving it horizontally to another direction. Because these adjustment buttons 83 and 84 are for moving the cross point 81 in the horizontal direction, these adjustment buttons 83 and 84 are displayed on the screen 82 side by side in the horizontal direction for making the operation of them to be easy.

When the user pushes the adjustment button 83 with the input unit 57, the MPU 59 moves the cross point 81 to the front direction, i.e. to the lower left direction on the screen 82 of FIG. 14A. Then, when the cross point 81 has moved to the position of the flower for example, the positions of the persons in the picked up picture for a right eye 78a and the picked up picture for a left eye 78b are displayed on the display 55 as if they are shifted to one direction, and the positions of the mountains in the pictures are displayed on the display 55 as if they are more shifted to the same direction. The user wearing the shutter spectacles 4 consequently sees the pictures as if the person is located at the rear of the flower as a reference position and the mountain is located at the further rear of the person. Moreover, when the user pushes the adjustment button 84 with the input unit 57, the MPU 59 moves the cross point 81 to the rear direction, i.e. to the upper right direction on the screen 82 of FIG. 14A. Then, when the cross point 81 has moved to the position of the mountain for example, the positions of the persons in the picked up picture for a right eye 78a and the picked up picture for a left eye 78b are displayed on the display 55 as if they are shifted to another direction, and the positions of the flowers in the pictures are displayed on the display 55 as if they are more shifted to the same direction. The user consequently sees the pictures as if the person is located at the front of the mountain as a reference position and the flower is located at the further front of the person. The user can thus adjust the depth of the picture, i.e. the cross point 81, at the position where it is easiest for the user to look at the stereoscopic picture.

At step S16, the adjustment of the picture in the vertical direction is performed for making it easiest for the user to look at the stereoscopic picture. That is, when photographing is performed with the digital camera 2 with the attached adapter 5, there is a case where the adapter 5 is attached to the digital camera 2 in an inclined state and the photographed picture 41 shown in FIG. 5 is also inclined. It is difficult to see such an inclined picture 41 stereoscopically. Accordingly, at the step S16, the MPU 59 makes the display 55 display adjustment buttons 85 and 86 on the screen 82 for adjusting the picked up picture for a right eye 78a and the picked up picture for a left eye 78b in the vertical direction. When the user pushes the adjustment button 85 with the input device 57, the MPU 59 shifts the picking up picture for a right eye 78a to the upper side, and shifts the picked up picture for a left eye 78b to the lower side on the screen 82. Moreover, when the user pushes the adjustment button 86 with the input device 57, the MPU 59 shifts the picked up picture for a right eye 78a to the lower side, and shifts the picked up picture for a left eye 78b to the upper side on the screen 82. The user can thus adjust the vertical positions of the picked up picture for a right eye 78a and the picked up picture for a left eye 78b to the positions where it is easiest for the user to look at a stereoscopic picture. Incidentally, because the adjustment buttons 85 and 86 are for making the pictures move in the vertical direction, the adjustment buttons 85 and 86 are displayed on the screen 82 side by side in the vertical direction.

In the aforesaid preview mode, because the depth of the picture, or the cross point 81, can be adjusted with the adjustment buttons 83 and 84 displayed on the screen 82, and because the displayed positions of the picked up picture for a right eye 78a and the picked up picture for a left eye 78b can vertically be adjusted with the adjustment buttons 85 and 86 displayed on the screen 82, it is possible to store the picked up picture for a right eye 78a and the picked up picture for a left eye picture 78b into the HDD 51 after the adjustment of their states so that a stereoscopic picture become easiest for the user to look at.

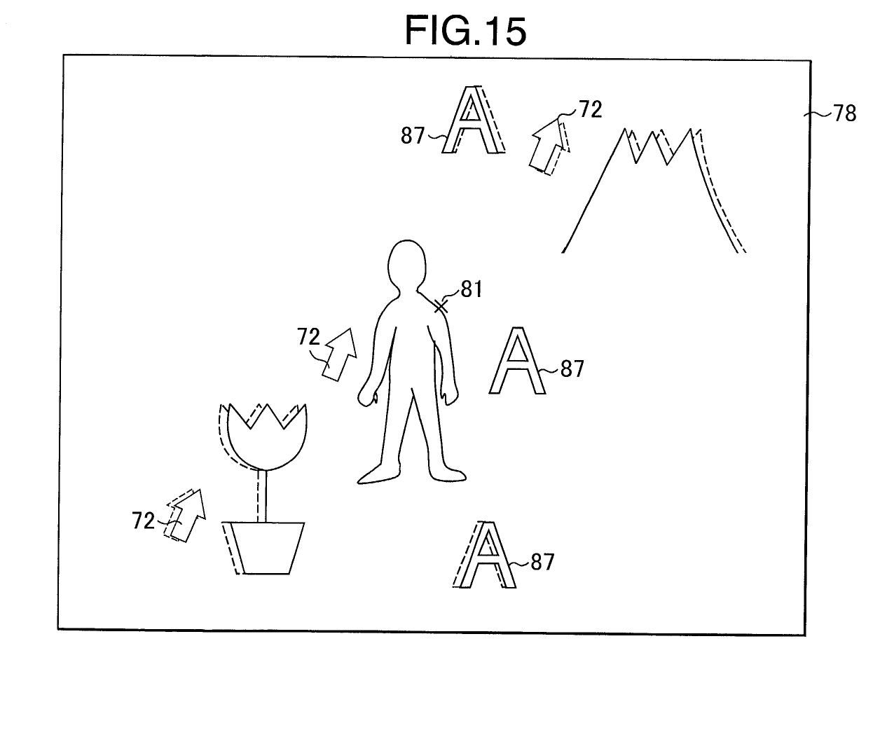

Now, as shown in FIG. 15, there is a case where, for example, the pointer 72 by the mouse 57b constituting the input unit 57 is moved on the stereoscopic picture 78 composed of the picked up picture for a right eye 78a and the picked up picture for a left eye 78b that are alternatively displayed in the aforesaid preview mode. When the pointer 72 is displayed two-dimensionally, i.e. in the display state at the cross point 81 in this case, it becomes hard for an user to look at the pointer 72. Accordingly, the MPU 59 makes the display 55 shift the displayed pointer 72 in accordance with the parallax at the position of the pointer 72 on the stereoscopic picture, i.e. the amount of the shift between the picked up picture for a right eye 78a and the picked up picture for a left eye 78b. That is, when the cross point 81 is situated at the person and the pointer 72 is situated near to the mountain at a rear position in the stereoscopic picture 78 as shown in FIG. 15, the MPU 59 makes the display 55 display the pointer 72 to be shifted in accordance with the amount of the shift between the picked up picture for a right eye 78a and the picked up picture for a left eye 78b at this position. Moreover, when the pointer 72 is situated near to the flower at a front position in the stereoscopic picture 78, the MPU 59 makes the display 55 display the pointer 72 to be shifted in accordance with the amount of the shift between the picked up picture for a right eye 78a and the picked up picture for a left eye 78b at this position. Moreover, when the pointer 72 is situated at the cross point 81, the MPU 59 makes the display 55 display the pointer 72 flatwise without shifting it, because there is no shift between the picked up picture for a right eye 78a and the picked up picture for a left eye 78b. Thereby, because the user can stereoscopically look at the pointer 72 that is always displayed in accordance with the parallax of the picture existing as a background when the pointer 72 moves on the stereoscopic picture 78 displayed stereoscopically, it can be prevented that it becomes hard for the user to look at the pointer 72.

Moreover, as shown in FIG. 15, a character 87 can be input into the picture 41 when the picture 41 is edited. That is, when a position where the character 87 is input in the stereoscopic picture 78 by the pointer 72 by the mouse 57b and a character (e.g. “A”) is input with the keyboard 57a, the MPU 59 makes the display 55 display the character 87 at the designated position in the stereoscopic picture 78. At this time, the MPU 59 makes the display 55 display the character 87 in accordance with the parallax at the coordinates on the stereoscopic picture 78 where the character 87 is input, i.e. the amount of the shift between the picked up picture for a right eye 78a and the picked up picture for a left eye 78b. That is, when the cross point 81 is situated at the person and the character 87 is displayed near to the mountain located at a rear position in the stereoscopic picture 78, the MPU 59 makes the display 55 display the character 87 to be shifted in accordance with the amount of the shift between the picked up picture for a right eye 78a and the picked up picture for a left eye 78b at the position. Moreover, when the character 87 is situated near to the flower at a front position in the stereoscopic picture 78, the MPU 59 makes the display 55 display the character to be shifted in accordance with the amount of the shift between the picked up picture for a right eye 78a and the picked up picture for a left eye 78b at the position. Moreover, when the character 87 is displayed at the cross point 81, the MPU 59 makes the display 55 display character 87 flatwise without shifting it, because there is no shift between the picked up picture for a right eye 78a and the picked up picture for a left eye 78b. Thereby, because the user can stereoscopically look at the character 87 that is always displayed in accordance with the parallax of the picture existing as a background when the character 87 is displayed on the stereoscopic picture 78 displayed stereoscopically, it can be prevented that it becomes hard for the user to look at the character 87. Moreover, when the amount of the shift of the character 87 is adjusted to the amount of the shift at the most front position in the picture 78, the character 87 seems for the user to be at the most front position, and thereby the character 87 can be emphasized.

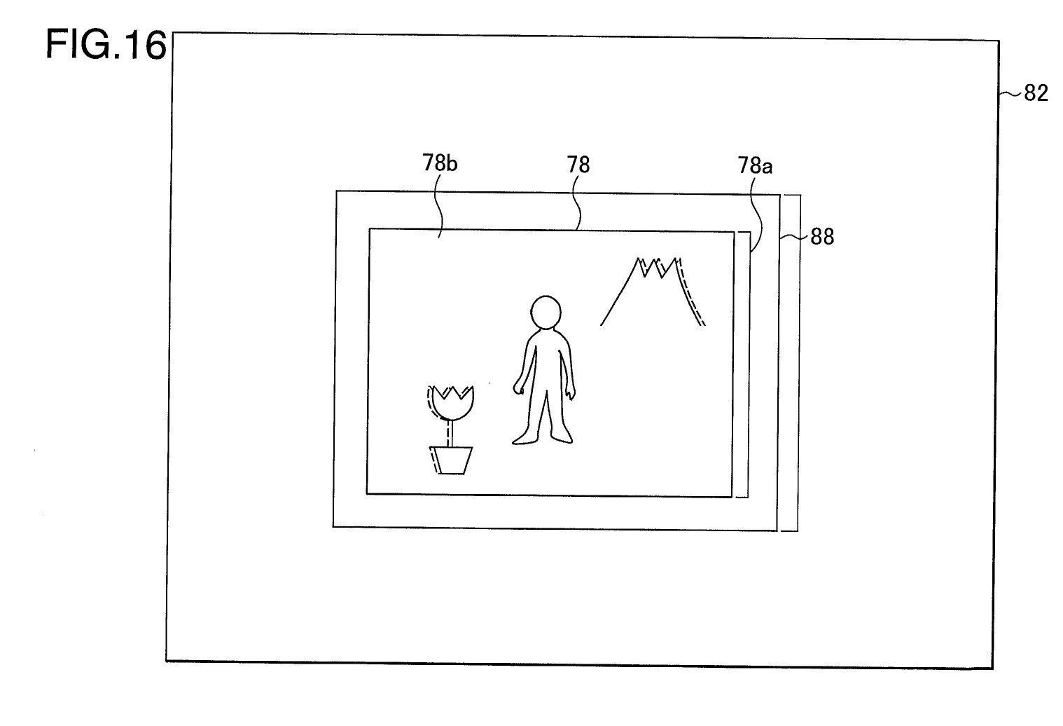

Moreover, when the picked up picture for a right eye 78a and the picked up picture for a left eye 78b are alternately displayed as shown in FIG. 14A, the surface to be a reference is the screen 82 of the display 55 or the frames 79a to 79c shown in FIG. 13A to 13C, respectively. That is, the screen 82 and the frames 79a to 79c on the screen 82 are displayed in a flatwise display form in which the parallax is not considered. Consequently, because the perimeter of the stereoscopic picture 78 displayed on the screen 82 is displayed flatwise, it becomes hard for the user, who wears the shutter spectacles 4 and are looking at the stereoscopic picture 78 of FIG. 14A, to look at the stereoscopic picture 78 stereoscopically. Accordingly, a frame body 88 having a prescribed width, for example, a casing, is displayed around the stereoscopic picture 78 as shown in FIG. 16. When the amount of the shift of the frame body 88 is set to be the same as that of an object displayed at the most front position, e.g. the flower, it becomes possible to show the stereoscopic picture 78 to the user as if the stereoscopic picture 78 is stereoscopically displayed on the inside of the frame body 88. Moreover, when the amount of the shift of the frame body 88 is set to be the same as that of an object displayed at the most rear position, e.g. the mountain, it becomes possible to show the stereoscopic picture 78 to the user as if the stereoscopic picture 78 itself is protruded out of the frame body 88. By the provision of the frame body 88 with the prescribed width around the stereoscopic picture 78 in such a way, it is possible to make it easier for the user to look at the stereoscopic picture.

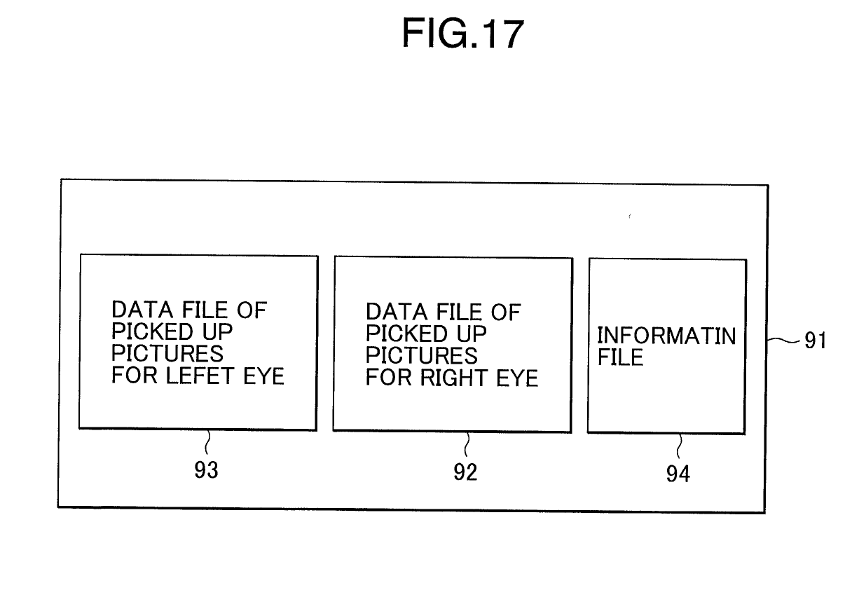

Next, the management method of the thus edited picture data of the stereoscopic picture 78 composed of the picture data of the picked up picture for a right eye 78a and the picture data of the picked up picture for a left eye 78b, namely the data management method at the step S9 in the aforesaid FIG. 10, will be described by reference to FIG. 17. When the picture data of the picked up picture for a right eye 78a and the picture data of the picked up picture for a left eye 78b, both picked up pictures being shown in FIG. 14A, are stored, a save button 89 displayed on the screen 82 is first pushed with the mouse 57b of the input unit 57 or other devices. When the save button 89 is pushed by the pointer 72, the MPU 59 stores the picture data of the picked up picture for a right eye 78a and the picture data of the picked up picture for a left eye 78b on the RAM 52 into the HDD 51 or the IC card 8 through a bus. To put it more concretely, as shown in FIG. 17, the MPU 59 stores a data file of picked up pictures for a right eye 92, a data file of picked up pictures for a left eye 93 and an information file 94 which consists of the information relating to the files 92 and 93 into a folder 91.

The data file of picked up pictures for a right eye 92 is a data file of the picture data of the picked up pictures for a right eye 78a picked up at the step S7 in FIG. 10, and the picture data have compressed in the JPEG system by the compressing/expanding section 58. Moreover, the data file of picked up pictures for a left eye 93 is a data file of the picture data of the picked up pictures for a left eye 78b, and the picture data have compressed in the JPEG system by the compressing/expanding section 58.

The coordinates of the cross point 81 when the picked up picture for a right eye 78a and the picked up picture for a left eye 78b are alternately displayed are stored in the information file 94. Moreover, as described above, when the picked up picture for a right eye the even lines of which have been thinned out and the picked up picture for a left eye the odd lines of which have been thinned out are displayed on the display 55, the line information indicating which of the pictures the first line of a picture to be displayed is included in is stored. That is, the information file 94 includes the data necessary to reproduce a stereoscopic picture at the time when the stereoscopic picture is stored.

Because the data file of picked up pictures of a right eye 92, the data file of picked up pictures of a left eye 93, and the information file 94 are separately provided in the aforesaid data management method, these data can be re-edited even if these data are compressed and expanded. That is, because the folder 91 includes the data file of cut put pictures for a right eye 92 and the data file of picked up pictures for a left eye 93, the user can perform the re-editing such as the expansion or compression of the picked up picture for a right eye 78a and the picked up picture for a left eye 78b.

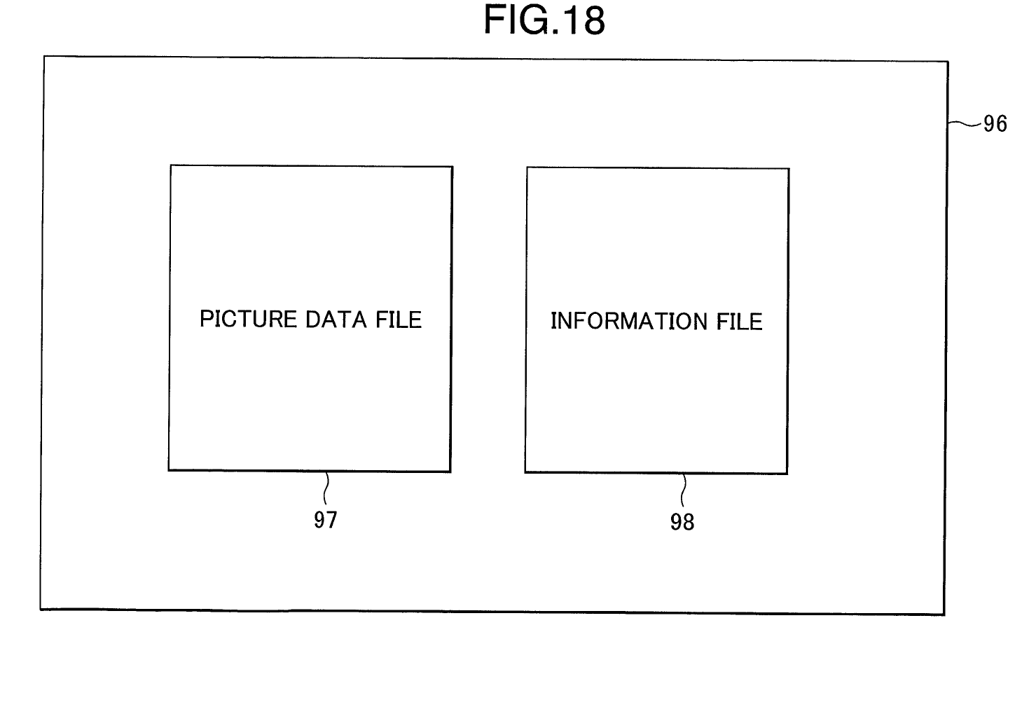

Moreover, the picture data of the picked up pictures for the right eye 78a and the picture data of the picked up pictures for the left eye 78b can also be stored as shown in FIG. 18. That is, there are stored in the folder 96 a picture data file 97 including the picture data of the picture 41 composed of the picture for a right eye 41a and the picture for a left eye 41b as shown in FIG. 5 and an information file 98 composed of the information for generating the picked up picture for a right eye 78a and the picked up picture for a left eye 78b from the picture data file 97. That is, the picture data file 97 is a file including the picture data compressed in the JPEG format by the compressing/expanding section 58 before the edit processing shown in FIG. 10. Moreover, there are stored in the information file 98 the position data of the division line 71, the position data of the vertical center lines 73a and 73 b, the position data of the horizontal center line 74, and the position data of the picked up lines 77a and 77b, all of the lines 71, 73a, 73b, 74, 77a and 77b being shown in FIG. 1D. Moreover, the coordinates of the cross point 81 when the picked up picture for a right eye 78a and the picked up picture for a left eye 78b are alternately displayed are stored in the information file 96. Moreover, when a picked up picture for a right eye formed by the thinning out of even lines from a picked up picture for a right eye of one frame and a picked up picture for a left eye formed by the thinning out of odd lines from a picked up picture for a left eye of one frame are displayed on the display 55, the line information indicating which of the pictures the first line of a picture to be displayed is included in is stored. That is, the information file 98 includes the data necessary to reproduce a stereoscopic picture at the time when the stereoscopic picture is stored.

Because the picture data of the picture 41 composed of the picture for a right eye 41a and the picture for a left eye 41b are preserved in the aforesaid data management method, more editorial operations can be performed in comparison with the storing method shown in FIG. 17 even if the picture data are compressed and expanded. To put it concretely, in the management method, the picture data file 97 and the information data file 98, both being stored in the folder 96, are read out from the folder 96, and the re-editing operation of a picture, for example, the editing operation such as the picked up of a picture as shown in FIG. 10 and FIG. 11, can be performed on the basis of the data in the read out files 97 and 98.

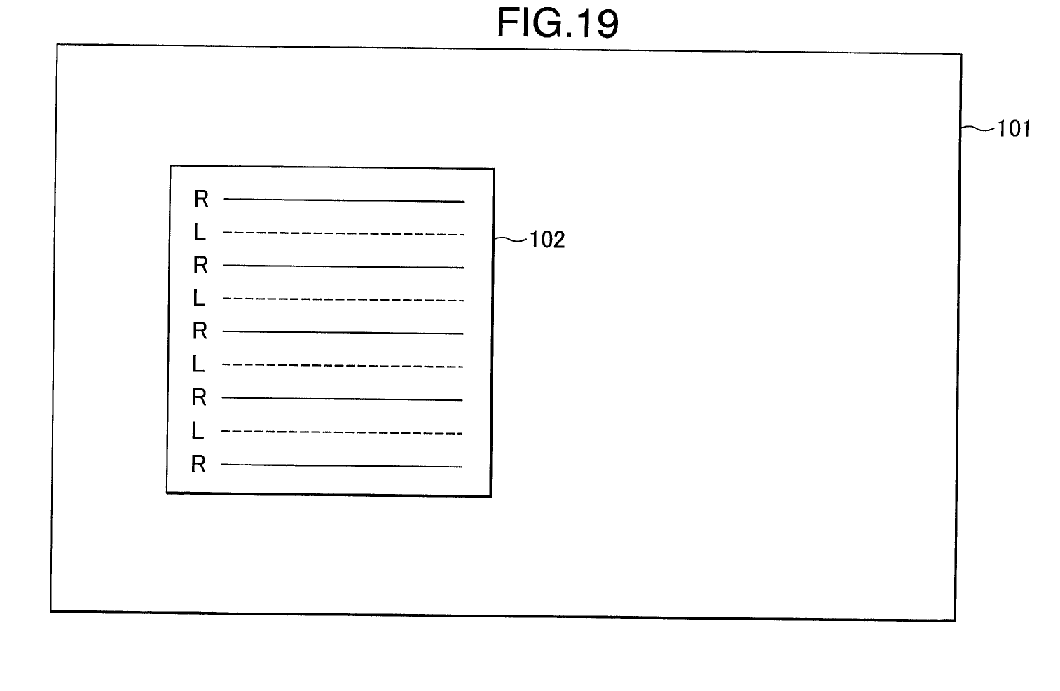

Moreover, the picture data of the picked up picture for a right eye 78a and the picture data of the picked up picture for a left eye 78b can also be stored as follows. That is, the storing method is a method for storing synthesized picture data composed of the data on the horizontal scan lines of the picture data of the picked up picture for a right eye 78a and the data on the horizontal scan lines of the picture data of the picked up picture for a left eye 78b, both of the data being alternatively taken into the synthesized picture data. As shown in FIG. 19, there is stored in a folder 101 a synthesized picture data file 102 in which the synthesized picture data formed by the synthesis of the picture data of a picked up picture for a right eye formed by the thinning out of even lines from a picked up picture for a right eye of one frame and the picture data of a picked up picture for a left eye formed by the thinning out of odd lines from a picked up picture for a left eye of one frame.

Because any information file is not provided in such a management method in comparison with the management methods of picture data shown in FIG. 17 and FIG. 18, the re-editing cannot be performed but the data size can be reduced. Incidentally, there may be stored in the folder 101 the data file of picked up pictures for a right eye 92, the data file of picked up pictures for a left eye 93, and the information file 94 including the information relating to the these files 92 and 93, all of the files 92, 93 and 94 being shown in FIG. 17, in addition to the synthesized picture data file 102. Moreover, there may be stored in the folder 101 the picture data file 97 including the picture data of the picture 41 composed of the picture for a right eye 41a and the picture for a left eye 41b and the information file 98 including the information for generating the picked up picture for a right eye 78a and the picked up picture for a left eye 78b from the picture data in the picture file 97, both of the files 97 and 98 being shown in FIG. 18, in addition to the synthesized picture data file 102.

Although different data management methods have been described by reference to FIG. 17 to FIG. 19 in the above, in the controlling unit 3, picture data may be stored in the HDD 51 in conformity with any one of the methods shown in FIG. 17 to FIG. 19. Moreover, any one of the methods shown in FIG. 17 to FIG. 19 may be selected so as to store picture data in the HDD 51. For example, the saving method shown in FIG. 17 is convenient to the suspension of an editing operation and the reediting, and the saving method shown in FIG. 18 is convenient in a case where a picture is sent to another party in a state of being attached to an electronic mail and the party performs the magnification or the reduction of the attached picture because the methods enables the easy magnification and reduction of the picture. Moreover, the saving method shown in FIG. 19 is convenient to preserve a home page or other Internet data.

By the way, a browsing software for reading out the data that is edited with the aforesaid editing program and is preserved in the form shown in FIG. 17 to FIG. 19 in the recording means such as the HDD 51 and for displaying pictures on the basis of the read out data on the display 55 will be described.

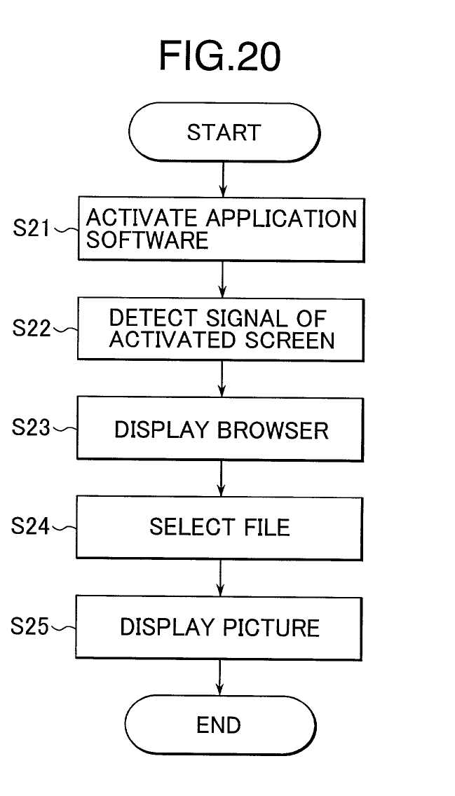

First, the activation of the browsing software is described by reference to FIG. 20. At step S21, when, for example, an icon for activating the browsing software displayed on the display 55 is clicked with the mouse 57b, the MPU 59 reads out the program of the browsing software to the RAM 52 from the HDD 51, and advances to step S22.

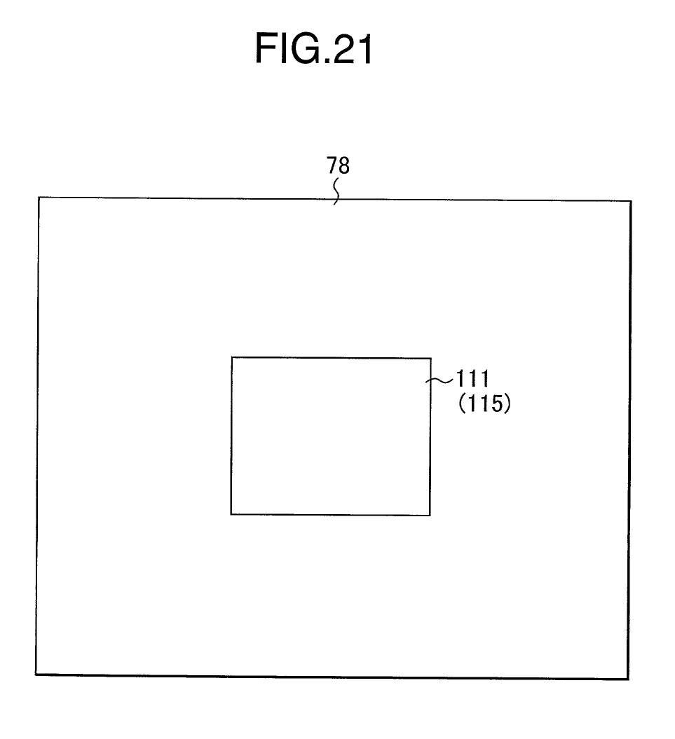

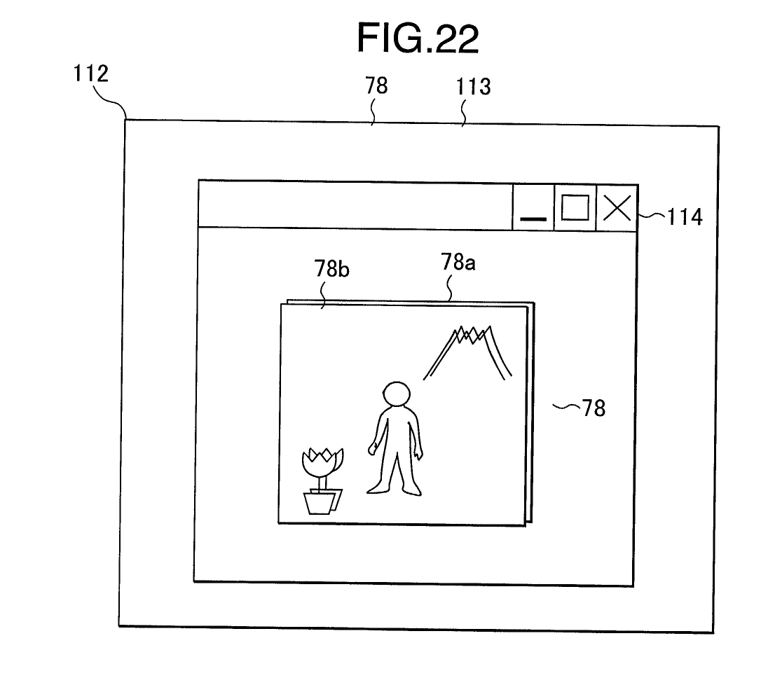

At the step S22, the MPU 59 makes the display 55 display an activation screen 111 shown in FIG. 21 at about the center of the screen 82. At this time, the controlling unit for spectacles 6 detects a signal of the activation screen 111 and controls of the turning on and off of the shutter section for a right eye 4a and the shutter section for a left eye 4b of the shutter spectacles 4. The details of the operation of the controlling unit for spectacles 6 will be described later.

At the step S24, the MPU 59 makes the display 55 display the screen of a browsing software 112 on the screen 82 of the display 55. That is, the VRAM 56 outputs the picture data of a picture for a right eye on the screen of the browsing software 112 to the display 55 from the memory section 56a, and outputs the picture data of a picture for a left eye on the screen of the browsing software 112 to the display 55 from the memory section 56b. The picture for a right eye and the picture for a left eye are alternately displayed on the screen of the browsing software 112 on the display 55 so as to have a parallax to each other. An user wearing the shutter spectacles 4 can thereby look at the screen of the browsing software 112 stereoscopically.

At step S25, the MPU 59 opens the folders including the picture data to be edited, i.e. the folders 91, 96, and 101 shown in FIG. 17 to FIG. 19, on the basis of a command from the input unit 57 composed of the keyboard 57a and the mouse 57b. Here, because the selected files 91, 96 and 101 are compressed in the JPEG format, the MPU 59 expands the files 91, 96 and 101 by the compressing/expanding section 58, and then reads out the data in the files 91, 96 and 101 to the RAM 52. Then, the MPU 59 makes the display 55 display the picked up picture for a right eye 78a and the picked up picture for a left eye 78b on the screen of the browsing software 112 displayed on the display 55 so as to have a parallax to each other. That is, when a picked up picture for a right eye formed by the thinning out of even lines from a picked up picture for a right eye of one frame and a picked up picture for a left eye formed by the thinning out of odd lines from a picked up picture for a left eye of one frame, the picture data of both the thinned out pictures being stored in the information files 94 and 98, are displayed on the display 55, the VRAM 56 outputs the picture data of the picked up picture for a right eye 78a from the memory section 56a at first, and then outputs the picture data of the picked up picture 78b for a left eye 78b from the memory section 56b on the basis of the line information indicating which of the pictures the first line of a picture to be displayed is included in. By the repetition of the outputting of the VRAM 56 after that, the stereoscopic picture 78 is displayed on the display 55. Consequently, the picked up picture for a right eye 78a and the picked up picture for a left eye 78b are further stereoscopically displayed in a frame body 113 displayed stereoscopically when they are seen by an user wearing the shutter spectacles 4. The screen of the browsing software 112 makes a stereoscopic picture easy for an user to look at by displaying further stereoscopic picture 78 in the stereoscopic frame body 113 in such a way.

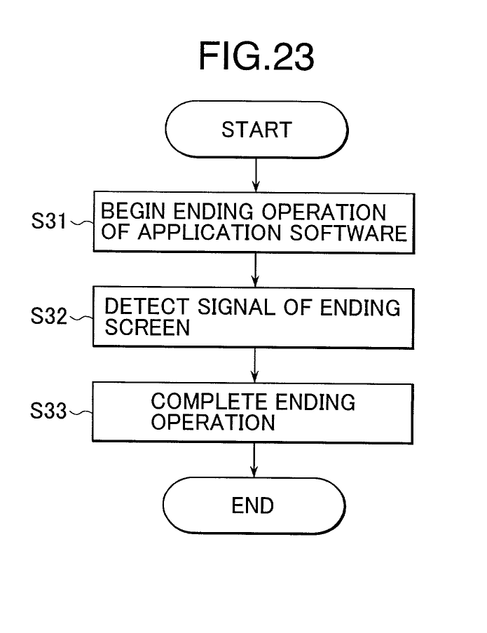

Moreover, the termination operation of the browsing software 112 will be described by reference to FIG. 23. At step S31, when the termination indication section 114 located at a corner position and indicated by an “x” is clicked by the mouse 57b, the MPU 59 begins the termination operation of the browsing software 112. Then, at step S32, the MPU 59 makes the display 55 display a termination screen 115 that is substantially the same as the activation screen 111 at about the center of the screen 82 of the display 55 as shown in FIG. 21. At this time, the controlling unit for spectacles 6 detects the signal of the termination screen 115, and turns off both of the shutter section for a right eye 4a and the shutter section for a left eye 4b of the shutter spectacles 4. The details of the operation of the controlling unit for spectacles 6 will be described later. Then, at step S33, the MPU 59 completes the termination operation of the browsing software 112.

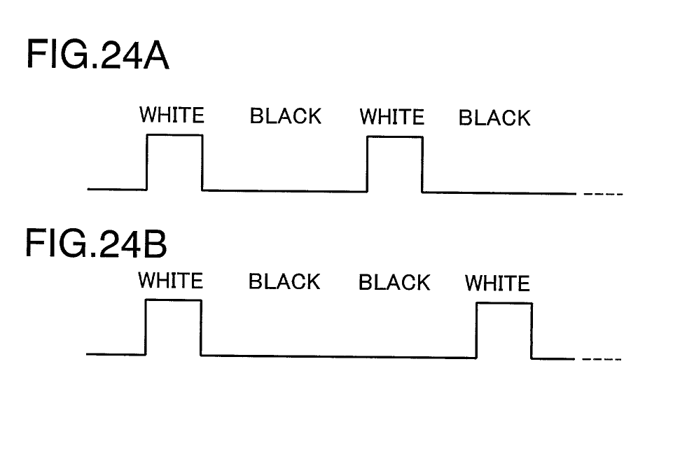

By the way, when the browsing software 112 is activated, it is necessary to drive the shutter spectacles 4. Accordingly, the step S22 shown in FIG. 20 is provided. That is, the controlling unit for spectacles 6 is set to detect whether the browsing software 112 is activated or not when the activation screen 111 is displayed on the screen 82 of the display 55. That is, when the browsing software 112 is activated, as shown in FIG. 24A, the VRAM 56 is set to supply a picture signal in the pattern of, for example, white ? black ? white ? black, for displaying the activation screen 111 to the display 55.

Now, the detecting section 61 of the controlling unit for spectacles 6 shown in FIG. 7 detects the picture signal in the patter of white ? black ? white ? black, and switches the switch 64 so as to turn off the shutter section for a right eye 4a of the shutter spectacles 4 and so as to turn on the shutter section for a left eye 4b thereof in accordance with the picture data of a picture for a right eye on the screen of the browsing software 112 output from the memory section 56a at first at the step S25 in FIG. 20 so that an user can look at the picture for a right eye with the user's right eye. When the picture for a right eye is displayed on the display 55, the shutter section for a right eye 4a takes the open state and the shutter section for a left eye 4b takes the closing state consequently.

Next, as shown in the aforesaid FIG. 8, when the detecting section 61 detects the vertical synchronizing signal of the data of a picture for a right eye, the detecting section 61 switches the switch 64 so as to turn off the shutter section for left eye 4b of the shutter spectacles 4 and so as to turn on the shutter section for a right eye 4a so that the user can look at the picture for a left eye to be displayed on the screen of the browsing software 112 next with the user's left eye. When the picture for a left eye is displayed on the display 55, the shutter section for a left eye 4b takes the open state and the shutter section for a right eye 4a takes the closing state consequently. Hereafter, by such switching of the shutters of the shutter section for a right eye 4a and the shutter section for a left eye 4b of the shutter spectacles 4 is performed synchronously with the switching timing of the picture for a right eye 78a and the picture for a left eye 78b, the user can stereoscopically look at the picture on the screen of the browsing software 112 displayed on the display 55.

Incidentally, the MPU 59 may control the display 55 to display an icon, a character and other objects in the region on the screen 82 where the screen of the browsing software 112 is not displayed with a parallax when the MPU 59 detects a picture signal in the pattern of white ? black ? white ? black so that the user can look at all the objects displayed on the screen 82 stereoscopically. Consequently, the whole screen 82 becomes a stereoscopically displayed picture, and it is possible to prevent that the region where the stereoscopic picture 78 composed of the picked up picture for a right eye 78a and the picked up picture for a left eye 78b is not displayed is displayed flickeringly. The picture signal in the pattern of white ? black ? white ? black is used as a synchronizing signal for synchronizing the shutter spectacles 4 and the pictures displayed on the display 55, and also is used as a detection signal for detecting the opening of the browsing software 112.

Moreover, it is necessary to stop the driving of the shutter spectacles 4 when the browsing software 112 is terminated, and accordingly the step S32 shown in FIG. 23 is provided. That is, the controlling unit for spectacles 6 is set to detect whether the browsing software 112 has been terminated or not when the termination screen is displayed on the screen 82 of the display 55. That is, when the browsing software 112 is terminated, as shown in FIG. 24B, the VRAM 56 is set to supply a picture signal in the pattern of, for example, white ? black ? black ? white for displaying the termination screen 115 to the display 55.

Here, when the detecting section 61 of the controlling unit for spectacles 6 shown in FIG. 7 detects the picture signal in the pattern of white ? black ? black ? white, turns off both of the shutter section for a right eye 4a and the shutter section for a left eye 4b of the shutter spectacles 4 so that both of the shutter section 4a for a right eye and the shutter section for a left eye 4b take the open state because the stereoscopic picture becomes impossible to look at hereafter. That is, by the turning off of the shutter spectacles 4 to make the shutter sections 4a and 4b take the open state, two-dimensional display is made to be easy to look at when an user does not make the browsing software 112 be activated.

Incidentally, in the aforesaid case where an icon, a character and other objects in the region on the screen 82 where the screen of the browsing software 112 is not displayed are made to be displayed as a picture with a parallax to enable an user to look at the whole screen 82 stereoscopically, the MPU 59 makes the display 55 stop displaying the icon, the character and other objects as a picture with the parallax, and makes the display 55 display the objects having no parallax when the MPU 59 detects the picture signal in the pattern of white ? black ? black ? white. That is, the picture signal in the pattern of the white ? black ? black ? white is used as a detection signal to turn off the shutter spectacles 4, and is also used as a detection signal to detect the termination of the browsing software 112.

As described above, on the screen of the browsing software 112, when the browsing software 112 is activated, the picture signal in the patter of white ? black ? white ? black is output from the VRAM 56 and the picture signal is detected by the controlling unit for spectacles 6, and thereby the switching control of the liquid crystal shutters of the shutter section for a right eye 4a and the shutter section for a left eye 4b of the shutter spectacles 4 can be performed synchronously with the picture data of a picture for a right eye and the picture data of a picture for a left eye, both being alternately output to the display 55 and being displayed on the screen of the browsing software 112. Consequently, it is possible to remove a defect that, for example, when a picture for a right eye is displayed on the display 55, the shutter section for a right eye 4a takes the closing state and the shutter section for a left eye 4b takes the open state and consequently the picture for a right eye is looked at only with the left eye. Moreover, on the screen of the browsing software 112, when the browsing software 112 is terminated, the picture signal in the pattern of white ? black ? black ? white is output from the VRAM 56 and the output picture signal is detected by the controlling unit for spectacles 6, and then both of the shutter section for a right eye 4a and the shutter section for a left eye 4b of the shutter spectacles 4 are turned off to make both of the shutter section for a right eye 4a and the shutter section for a left eye 4b take the open state, and consequently a two-dimensional display can be made to be easy to look at. Moreover, it is possible to prevent from being noticeable to the user by the use of the above-mentioned picture signal for the activation screen 111 and the termination screen 115. Incidentally, the picture signals at the time of the activation and the termination of the browsing software 112 are not limited to the patterns of white ? black ? white ? black at the activation and white ? black ? black ? white at the termination, any color and combination may be adoptable provided that they are not conspicuous.

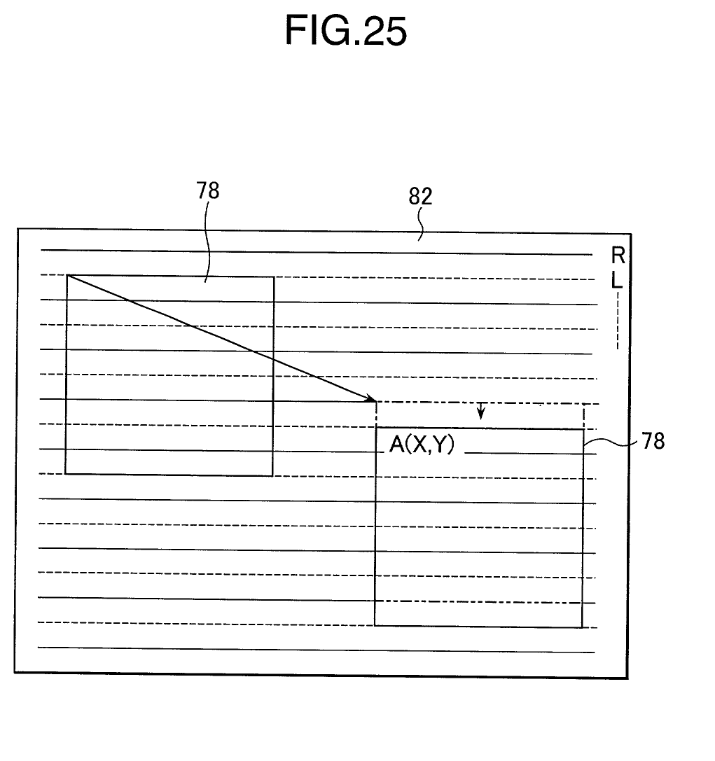

By the way, there is a case where a second stereoscopic picture is displayed on the display 55 in a way of being superimposed on the screen of the browsing software 112 displayed stereoscopically as a fist stereoscopic picture. For example, as shown in FIG. 25, it is such cases as a case where a stereoscopic picture having already been picked up is pasted on the screen of the browsing software 112 and a case where a stereoscopic picture 78 displayed on the screen of the browsing software 112 is moved. As shown in FIGS. 9A-9D and FIG. 25, in the case where a picked up picture for a right eye formed by the thinning out of the even lines of the horizontal scan lines of a picked up picture for a right eye of one frame and a picked up picture for a left eye formed by the thinning out of the odd lines of the horizontal scan lines of a picked up picture for a left eye of a frame are alternately displayed, when the stereoscopic picture 78 is pasted or moved on the screen of the browsing software 112, there happens a case where the horizontal scan lines of a picture for a left eye of the stereoscopic picture 78 are placed on the horizontal scan lines of a picture for a right eye of the screen of the browsing software 112. That is, a picture for a left eye of the stereoscopic picture 78 is displayed when a picture for a right eye is displayed on the screen of the browsing software 112, or a picture for a right eye of the stereoscopic picture 78 is displayed when a picture for a left eye is displayed on the screen of the browsing software 112. In such a case, the user has become impossible to look at the stereoscopic picture 78 stereoscopically. Accordingly, in the case where the horizontal scan lines of the screen of the browsing software 112 and the horizontal scan lines of the stereoscopic picture 78 do not agree with each other when the stereoscopic picture 78 is moved as shown in FIG. 25, the browsing software 112 moves the stereoscopic picture 78 by one horizontal scan line in the vertical direction so that the horizontal scan lines of the screen of the browsing software 112 and the horizontal scan lines of the stereoscopic picture 78 agree with each other.

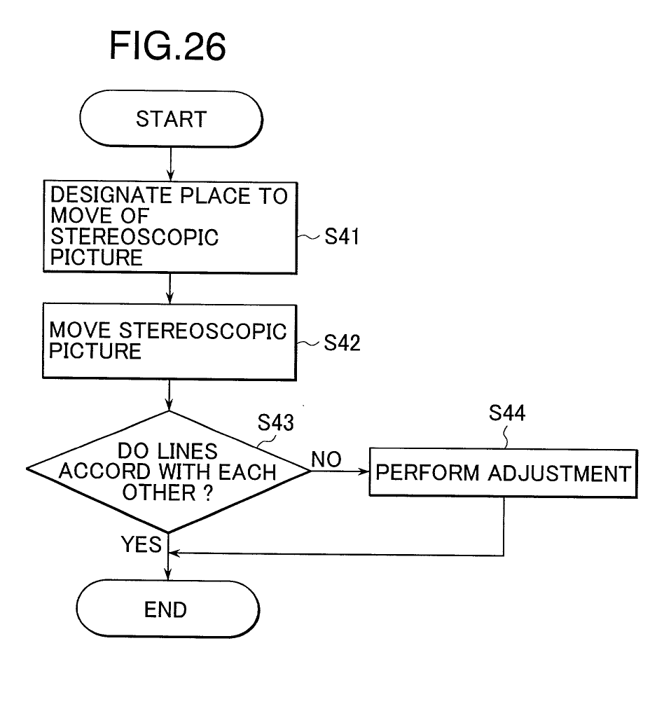

To put it concretely, as shown in FIG. 26, at step S41, for example, the stereoscopic picture 78 located at a first position on the upper left side in FIG. 25 is selected with the mouse 57b, and a second position on the lower right side in FIG. 25 is designated as the position of the stereoscopic picture 78 to be shifted or to be pasted. Then, at step S42, the MPU 59 moves the stereoscopic picture 78 located at the first position to the second position, or pastes the stereoscopic picture 78 at the second position.

Furthermore, at step S43, the MPU 59 detects whether the Y-coordinate of the position coordinates A(X, Y) of the stereoscopic picture on the upper most stream in the scanning direction at the second position as the position of the stereoscopic picture 78 to be moved or to be pasted is located on the horizontal scan line of a picture for right eye of the screen of the browsing software 112 or is located on the horizontal scan line of a picture for a left eye of the screen of the browsing software 112. Then, the MPU 59 terminates the processing thereof when the first horizontal scan line of the stereoscopic picture 78 and the horizontal scan line of the screen of the browsing software 112 agree with each other, and advances its processing to step S44 when the first horizontal scan line of the stereoscopic picture 78 and the horizontal scan line of the screen of the browsing software 112 do not agree with each other. That is, when the Y-coordinate is located on the horizontal scan line of a picture for a right eye in the screen of the browsing software 112 in the case where the first horizontal scan line of the stereoscopic picture 78 is a horizontal scan line of a picture for a right eye, the MPU 59 terminates the processing thereof on the supposition that the horizontal scan line of the screen of the browsing software 112 and the first horizontal scan line of the stereoscopic picture 78 agree with each other. Moreover, when the Y-coordinate is located on the horizontal scan line of a picture for a left eye in the screen of the browsing software 112 in the case where the first horizontal scan line of the stereoscopic picture 78 is a horizontal scan line of a picture for a right eye, the MPU 59 advances the processing thereof to the step S44 on the supposition that the horizontal scan line of the screen of the browsing software 112 and the first horizontal scan line of the stereoscopic picture 78 do not agree with each other.

At the step S44, the MPU 59 moves the stereoscopic picture 78 by one horizontal scan line upwardly or downwardly. Thereby, the MPU 59 make the first horizontal scan line of the stereoscopic picture 78 and the horizontal scan line of a picture on the screen of the browsing software 112 agree with each other, and enables an user to look at the stereoscopic picture 78 stereoscopically. Then, the MPU 59 terminates the processing thereof.

As described above, because on the screen of the browsing software 112, when the stereoscopic picture 78 is moved or pasted, the horizontal scan lines of a picture on the screen, which is a frame of the stereoscopic picture 78, of the browsing software 112 and the horizontal scan lines of the stereoscopic picture 78 always agree with each other, an user can always look at the stereoscopic picture.

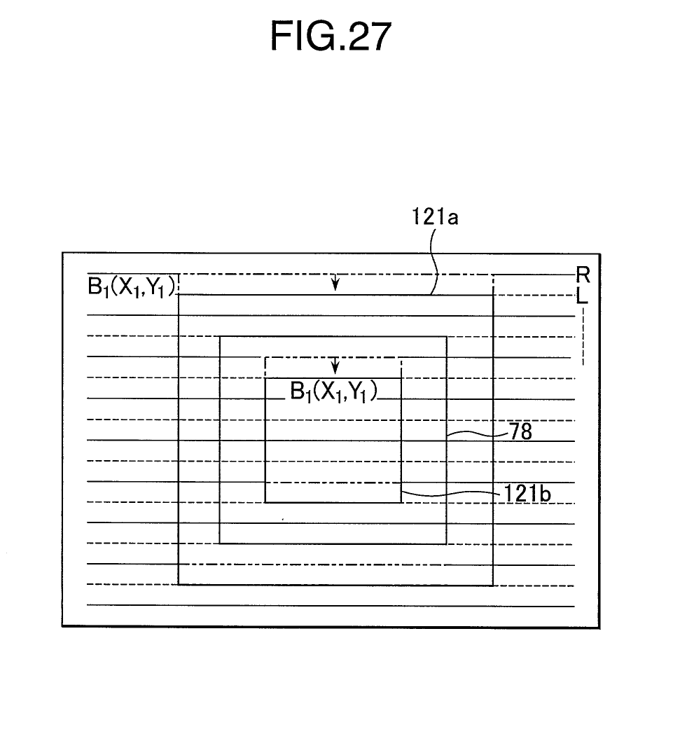

Moreover, as shown in FIG. 27, there is a case where the stereoscopic picture 78 as a second stereoscopic picture displayed on the screen of the browsing software 112 as a first stereoscopic picture is expanded or reduced. As shown in FIGS. 9A to 9D and FIG. 27, in the case where a picked up picture for a right eye formed by the thinning out of even horizontal scan lines of a picked up picture for a right eye of one frame and a picked up picture for a left eye formed by the thinning out of the odd horizontal scan lines of a picked up picture for left eye of one frame are alternately displayed, when the stereoscopic picture 78 is expanded or reduced on the screen of the browsing software 112, there is a case where the horizontal scan lines of a picture for a left eye of the stereoscopic picture 78 are situated on the horizontal scan lines of a picture for a right eye on the screen of the browsing software 112. That is, the picture for a left eye of the stereoscopic picture 78 is displayed when the picture for a right eye is displayed on the screen of the browsing software 112, or the picture for a right eye of the stereoscopic picture 78 is displayed when the picture for a left eye is displayed on the screen of the browsing software 112. In this case, an user becomes impossible to look at the stereoscopic picture 78 stereoscopically. Accordingly, in the case where the horizontal scan lines of the screen of the browsing software 112 and the horizontal scan lines of the stereoscopic picture 78 do not agree with each other when the stereoscopic picture 78 is expanded or reduced as shown in FIG. 27, the browsing software 112 moves the stereoscopic picture 78 by one horizontal scan line in the vertical direction so that the horizontal scan lines of the screen of the browsing software 112 and the horizontal scan lines of the stereoscopic picture 78 agree with each other.

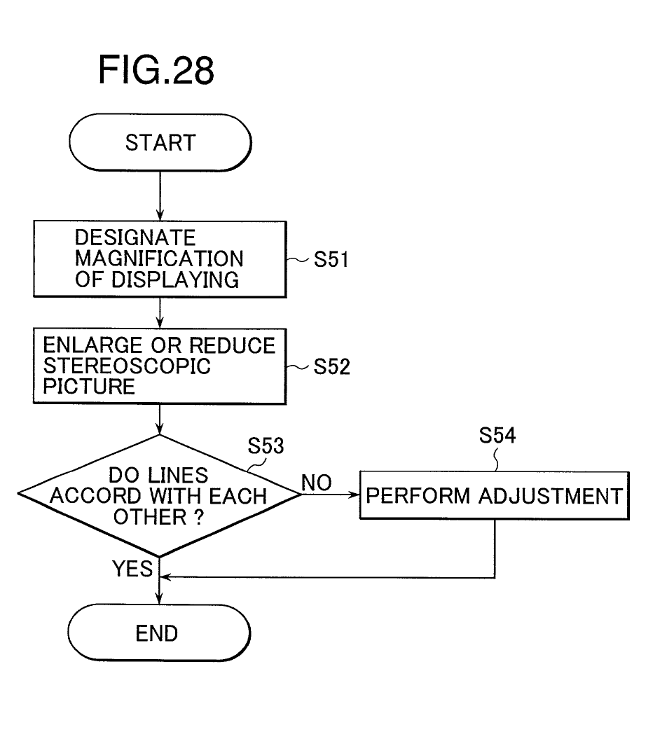

To put it concretely, as shown in FIG. 28, at step S51, a stereoscopic picture 78 is selected with the input unit 57, and the display magnification of the selected stereoscopic picture 78 is designated. Then, at step S52, the MPU 59 makes the display 55 display the stereoscopic picture 78 by expanding or reducing it at the display magnification designated by an user.

Then, at step S53, the MPU 59 detects whether the Y₁-coordinates and Y₂-coordinates of the position coordinates B₁(X₁, Y₁) and B₂(X₂, Y₂) of a picture 121a obtained by the expansion of the stereoscopic picture 78 or a picture 121b obtained by the reduction of the stereoscopic picture 78 on the upper most stream in the scanning direction is located on the horizontal scan line of a picture for a right eye on the screen of the browsing software 112 or is located on the horizontal scan line of a picture for a left eye on the screen of the browsing software 112. Then, the MPU 59 terminates the processing thereof when the first horizontal scan line of the picture 121a or 121b and the horizontal scan line of the screen of the browsing software 112 agree with each other, and advances the processing thereof to step S54 when the first horizontal scan line of the picture 121a or 121b and the horizontal scan line of the screen of the browsing software 112 do not agree with each other. That is, when the Y₁-coordinates and Y2coordinates are located on the horizontal scan line of a picture for a right eye on the screen of the browsing software 112 in the case where the first horizontal scan line of the picture 121a or 121b is a horizontal scan line of a picture for a right eye, the MPU 59 terminates the processing thereof on the supposition that the horizontal scan line of the screen of the browsing software 112 and the first horizontal scan line of the picture 121a or 121b agree with each other. Moreover, when the Y₁-coordinate and the Y₂-coordinate are located on the horizontal scan line of a picture for a left eye on the screen of the browsing software 112 in the case where the first horizontal scan line of the picture 121a or 121b is a horizontal scan line of a picture for a right eye, the MPU 59 advances the processing thereof to the step S54 on the supposition that the horizontal scan line of the screen of the browsing software 112 and the first horizontal scan line of the picture 121a or 121b do not agree with each other.

At the step S54, the MPU 59 moves the picture 121a or 121b by one horizontal scan line upwardly or downwardly. Thereby, the MPU 59 make the first horizontal scan line of the picture 121a or 121b and the horizontal scan line of a picture on the screen of the browsing software 112 agree with each other. Or, as anther method, the MPU 59 again makes the display 55 display the picture 121a or 121b by expanding or reducing at the magnification nearest to the display magnification designated by an user so that the first horizontal scan line of the picture 121a or 121b and the horizontal scan line of the picture on the screen of the browsing software 121 agree with each other. By means of the method described above, the MPU 59 makes the first horizontal scan line of the picture 121a or 121b and the horizontal scan line of the picture on the screen of the browsing software 112 agree with each other, and enables the user to look at the expanded or reduced picture 121a or 121b stereoscopically. Then, the MPU 59 terminates the processing thereof.

As described above, because on the screen of the browsing software 112, when the picture 121a or 121b is expanded or reduced, the horizontal scan lines of a picture on the screen, which is a frame of the picture 121a or 121b, of the browsing software 112 and the horizontal scan lines of the stereoscopic picture 78 always agree with each other, and thereby the user can always look at the stereoscopic picture.

By the way, the editing program for editing the picture composed of such a picture for a right eye 41a and a picture for a left eye 41b and the browsing software for looking at the picture edited with the editing program may be memorized to be preserved in a magnetic disk, a magneto-optical disk, an optical disk, a semiconductor memory and other recording media in addition that the editing program and the browsing software are memorized to be preserved in the HDD 51. In this case, when the recording media are loaded on the driving section 131 as shown in FIG. 6 and an operation for activating the recording media is performed with the input unit 57, these programs are read out by the MPU 59 from the recording media to the RAM 52 through a bus. Then, the above-mentioned processing is executed by the program read out from the record media.

Moreover, these programs may be installed in the HDD 51 from the driving section 131 through a provision medium for providing the programs to an user such as the magnetic disk, the magneto-optical disc, the optical disk, and the semiconductor memory where the programs are stored. Moreover, in addition to installing these programs in the HDD 51 through such a provision medium, it is also possible to install the programs in the HDD 51 through a transmitting/receiving section 132 by radio or by wire from a download site.

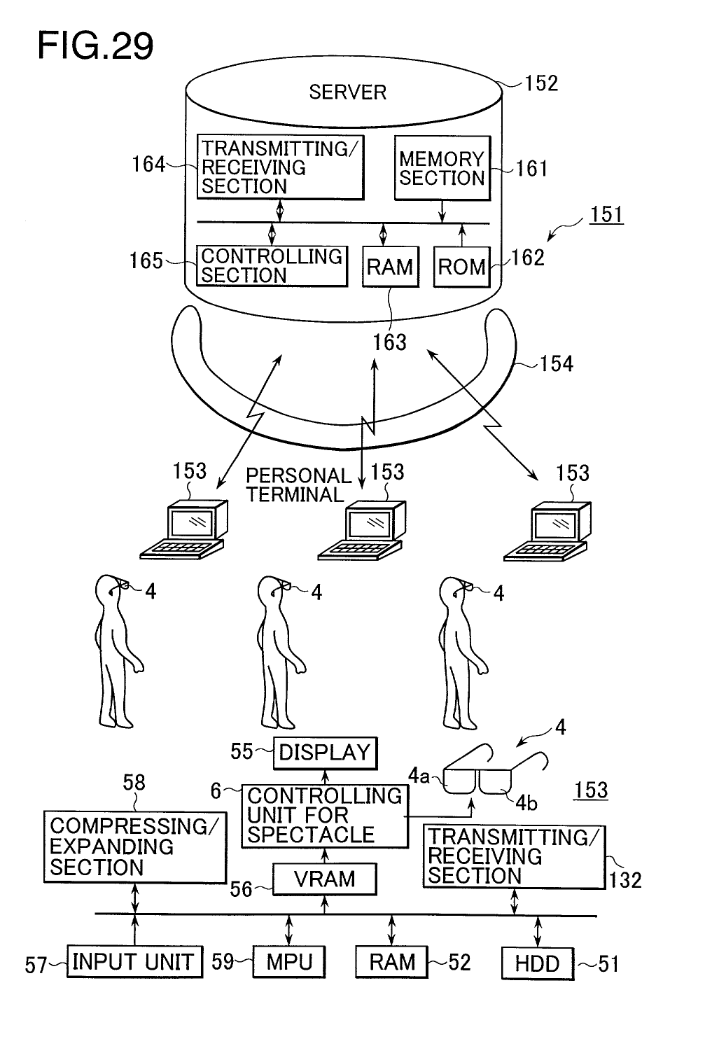

Next, a network system 151 using the thus structured stereoscopic picture system 1 will be described by reference to FIG. 29. The network system 151 is equipped with a server unit 152 for accumulating stereoscopic picture data and a plurality of personal terminal units 153 for downloading stereoscopic picture data by accessing the server unit 152. Then, the server unit 152 and the plural personal terminal units 153 are connected with each other through the network.

The server unit 152 has a structure that is substantially similar to that of an ordinary computer. The server unit 152 comprises a memory section 161 for storing the stereoscopic picture data and other data and programs, a read-only memory (hereinafter, also referred to as ROM) 162 for storing various programs such as a program for controlling the operation of the whole of the server unit 152, a RAM 163 for accepting a program stored in the ROM 162 temporarily, a transmitting/receiving section 164 for performing the transmission and the reception of data with the personal terminal units 153, and a controlling section 165 composed by a MPU for controlling the whole of the server unit 152.

The program for controlling the operation of the whole of the server unit 152 is read out from the ROM 162 to the RAM 163 temporarily to be executed by the controlling section 165 for controlling the operation of the whole of the server unit 152. In the server unit 152, a home page including a stereoscopic picture and other objects is provided in the memory section 161 to enable the personal terminal units 153 to access the home page.

Moreover, the personal terminal units 153 correspond to the aforesaid controlling unit 3 and have a structure similar to that of the controlling unit 3. That is, as shown in FIG. 29, each of the personal terminal units 153 comprises a HDD 51 for storing perusing and searching software (browsing software 112) for displaying a picture 41 stereoscopically, an electronic mail program and other programs, a RAM 52 for accepting temporarily an application program and other programs and data stored in the HDD 51, a display 55 for displaying the picture 41 and other pictures, a VRAM 56, an input unit 57, a compressing/expanding section 58 for expanding data in the JPEG format and for compressing data in the JPEG format, and a MPU 59 for controlling the whole of the personal terminal unit 153.

Each of the personal terminal units 153 is installed in, for example, a personal user's house, and is connected with a provider in the Internet 154 through a modulator-demodulator and a telephone line, a terminal adapter and the Integrated Services Digital Network (ISDN) line, a cable television (CATV) line, and other communication lines. For example, when an user peruses a home page provided in the server unit 152, the user operates the input unit 57 to perform the inputting operation of the uniform resource locator (URL) of a desired home page, and then the browsing software 112, the transmission control protocol/internet protocol (TCP/IP) and other programs are performed. As a result, the personal terminal unit 153 accesses the server unit 152 through the Internet 154 to download the contents of the accessed home page for displaying the contents on the display 55. Moreover, the user can transmit an electronic mail to the personal terminal unit 153 of another user through the Internet 154 by the use of the personal terminal unit 153 of the user on the transmission side.

Moreover, a pair of shutter spectacles 4 for looking at a picture displayed on the display 55 stereoscopically is connected with each of the personal units 153 between the VRAM 56 and the display 55 through the controlling unit for spectacles 6 as shown in FIG. 29. Consequently, the user can stereoscopically look at the picture that is displayed in the home page and has a parallax by wearing the shutter spectacles 4. A case where an user peruses a home page provided in the server unit 152 with a personal terminal unit 153 in the above-mentioned network system 151 will be explained. Data for a stereoscopic picture is stored in the server unit 152 as a picture having a parallax in, for example, a way shown in FIG. 19. As the data for the stereoscopic picture, as shown in FIG. 19, there is accumulated in the server unit 152 the synthesized picture data file 102 in which the synthesized picture data formed by the synthesis of the picture data of a picked up picture for a right eye formed by the thinning out of even lines from a picked up picture for a right eye of one frame and the picture data of a picked up picture for a left eye formed by the thinning out of odd lines from a picked up picture for a left eye of one frame. Because the data size of such a synthesized picture data file 102 is small, the time for downloading the synthesized picture data file 102 from the server unit 152 can be shortened.

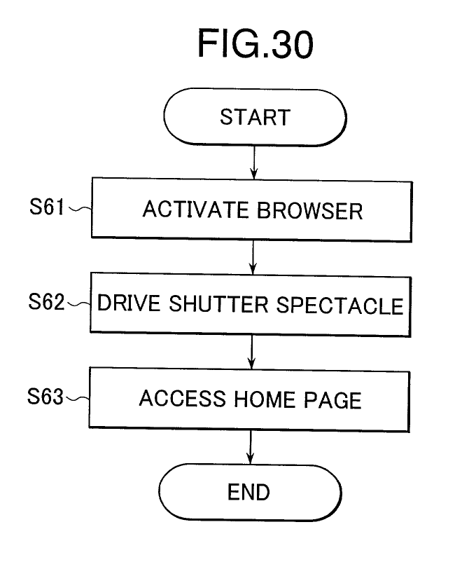

On the other hand, in the case where a home page is perused by a personal terminal unit 153 as shown in FIGS. 20 and 21, at first, at step S61 shown in FIG. 30, an icon for activating the browsing software that is displayed on the display 55 is clicked with the mouse 57b, and then the MPU 59 reads out the program of the browsing software from the HDD 51 to the RAM 52 for displaying the activation screen 111 shown in FIG. 21 on the screen 82 of the display 55. Here, as shown in FIG. 24A, the VRAM 56 supplies a picture signal in the pattern of white ? black ? white ? black for displaying the activation screen 111 to the display 55. The detecting section 61 of the controlling unit for spectacles 6 detects the picture signal in the pattern of white ? black ? white ? black, and detects that the browsing software 112 has been activated. When the activation of the browsing software 112 has been completed, the picture data of a picture for a right eye and the picture data of a picture for a left eye, both of the pictures being displayed on the screen of the browsing software 112, are alternately output from the VRAM 56, and then the picture for a right eye and the picture for a left eye are alternately displayed on the display 55 so as to have a parallax.

At the same time when the activation of the browsing software 112 has been completed, at step S62, the controlling unit for spectacles 6 controls the shutter spectacles 4 so that the shutter section for a right eye 4a of the shutter spectacles 4 takes the open state and the shutter section for a left eye 4b takes the closing state when the picture for a right eye is displayed on the screen of the browsing software 112, and then so that the shutter section for left eye 4b of the shutter spectacles 4 takes the open state and the shutter section for a right eye 4a takes the closing state when the picture for a left eye is displayed on the screen of the browsing software 112, and further so that the switching operations are repeated. By the execution of the switching of the shutters of the shutter section for a right eye 4a and the shutter section for a left eye 4b of the shutter spectacles 4 synchronously with the timing of the switching of the picture for a right eye and the picture for a left eye displayed on the screen of the browsing software 112, an user can stereoscopically look at a picture displayed on the display 55 by the browsing software 112.

Then, at step S63, when an user performs the input operation of the URL of a desired home page by operating the input unit 57, the personal terminal unit 153 accesses to the server unit 152 through the Internet 154, and downloads the contents of the accessed home page to display the contents on the display 55. Moreover, a stereoscopic picture provided in the home page may also be selected to be downloaded. The picture data of the selected stereoscopic picture is accumulated in the memory section 161 of the server unit 152 in the way shown in FIG. 17. The picture data shown in FIG. 17 is composed of the data file of picked up pictures for a right eye 92, the data file of picked up pictures for a left eye 93 and the information file 94 which consists of the information relating to the files 92 and 93. Because there are the data file of picked up pictures for a right eye 92 and the data file of picked up pictures for a left eye 93 in the picture date, it is possible to perform the editing operations of expanding or reducing the picture for a right eye and the picture for a left eye in conformity with the editing program in the personal terminal unit 153.

In the aforesaid network system 151, the picture data for a stereoscopic picture is accumulated in the server unit 152 in the way shown in FIG. 17 or FIG. 19, and an user wearing the shutter spectacles 4 looks at a home page displayed on the display 55 on the personal terminal unit 153 side, and thereby the user can stereoscopically look at the picture displayed on the display 55. For example, when the user purchases goods through the Internet 154, the user can stereoscopically look at the goods and it becomes possible for the user to perform easily the judgment whether the user should purchase the goods or not.

Moreover, in the network system 151, electronic mails can also be exchanged among the personal terminal units 153. For example, there is a case where the picture data photographed with the aforesaid digital camera 2 with the attached adapter 5 and processed by the aforesaid edit processing is attached to an electronic mail to be transmitted to another personal terminal unit 153. Now, a case where picture data is preserved in the HDD 51 of a personal terminal unit 153 on the transmission side in the way shown in FIG. 17 will be explained. In this case, as described above, there are stored in the folder 91 the data file of picked up pictures for a right eye 92, the data file of picked up pictures for a left eye 93 and the information file 94 which consists of the information relating to the files 92 and 93.

At the personal terminal unit 153 on the transmission side, an user operates the input unit 57 to transmit the folder 91 to the address of the server equipment 152 which is the transmission place. The transmitted folder 91 is thereby accumulated in the memory section 161 of the server unit 152. After that, when the personal terminal unit 153 of an user who is an addressee accesses the address of the server unit 152, the personal terminal unit 153 of the addressee downloads the folder 91 to accumulate it in the HDD 51.

In the personal terminal unit 153 on the side of the addressee, when the addressee looks at the picture preserved in the folder 91, the browsing software 112 is activated by the processing shown in FIG. 20. Then, the user as the addressee opens the received file 91, and the data file of picked up pictures for a right eye 92 and the data file of picked up pictures for a left eye 93 are read out from the VRAM 56 to be displayed on the display 55 alternately in a way that the picked up picture for a right eye and the picked up picture for a left eye have a parallax on the display 55. Thereby, the user can look at the picture displayed on the screen of the browsing software 112 stereoscopically in a state that the user wears the shutter spectacles 4. By the way, because there are the data file of picked up pictures for a right eye 92 and the data file of picked up pictures for a left eye 93 in the folder 91, the user can perform the re-editing of the picked up picture for a right eye 78a and the picked up picture for a left eye 78b such as the enlarging or the reducing of them.

Next, a case where picture data are preserved in the HDD 51 in the way shown in FIG. 18 will be described. In this case, as described above, there are preserved in the folder 96 the picture data file 97 including the picture data of the picture 41 composed of the picture for a right eye 41a and the picture for a left eye 41b as shown in FIG. 5 and the information file 98 composed of the information for generating the picked up picture for a right eye 78a and the picked up picture for a left eye 78b from the picture data file 97.

The personal terminal unit 153 on the transmission side transmits the folder 96 to the personal terminal unit 153 of the user who is the addressee through the server unit 152 by the operation of the input device 57 by the user on the transmission side.

In the personal terminal unit 153 on the side of the addressee, when the addressee looks at the picture preserved in the folder 96, the browsing software 112 is activated by the processing shown in FIG. 20. Then, the user as the addressee opens the received file 97, and the data file of picked up pictures for a right eye 92 and the data file of picked up pictures for a left eye 93 are read out from the VRAM 56 to be displayed on the display 55 alternately in a way that the picked up picture for a right eye and the picked up picture for a left eye have a parallax on the display 55. Thereby, the user can look at the picture displayed on the screen of the browsing software 112 stereoscopically in a state that the user wears the shutter spectacles 4. Now, because there is the picture data file 97 in the folder 96, the user can perform the re-editing of the picture for a right eye and the picture for a left eye such as the enlarging or the reducing of them as shown in FIG. 10.

Because each personal terminal unit 153 has at least the browsing software 112 in the aforesaid network system 151, the picture data of a stereoscopic picture can be exchanged by the attachment of the stereoscopic picture to an electronic mail.

Although examples in which picture data are compressed in the JPEG format to be preserved or processed by other processing are described in the above, the compressing system of the present invention may be the motion picture expert group (MPEG) and other systems. Moreover, although examples concerning static images are described in the above, dynamic images are also adoptable. Although the invention has been described in its preferred form with a certain degree of particularity, obviously many changes and variations are possible therein. It is therefore to be understood that the present invention may be practiced than as specifically described herein without departing from scope and the sprit thereof.

What is claimed is:

1. A stereoscopic picture displaying apparatus, comprising:
memory means for storing a stereoscopic picture data including a right eye picture and a left eye picture;
display means for displaying a stereoscopic picture based on said stereoscopic picture data stored in said memory means on a display screen;
position-inputting means for operating pointing means for pointing a prescribed position on said display screen of the display means; and
controlling means for controlling said display means to display said right eye picture and said left eye picture alternately on said display screen of the display means so as to have a parallax between said right eye picture and said left eye picture,
wherein said controlling means controls said display means to display said pointing means so as to have a parallax in accordance with an amount of the parallax at a pointing position of said pointing means when said pointing means is displayed to locate at a prescribed position on said stereoscopic picture.

2. A stereoscopic picture displaying apparatus, comprising:
memory means for storing a stereoscopic picture data including a right eye picture and a left eye picture;
display means for displaying said stereoscopic picture based on said stereoscopic picture data stored in said memory means on a display screen;
character-inputting means for inputting characters to said display means to be displayed on said display screen; and
controlling means for controlling said display means to display said right eye picture and said left eye picture alternately on said display screen of the display means so as to have a parallax between said right eye picture and said left eye picture,
wherein said controlling means controls said display means to display characters so as to have a parallax in accordance with an amount of the parallax at a position at which the characters are input when the characters are input at a prescribed position on said stereoscopic picture by said character-inputting means.

3. A stereoscopic picture displaying apparatus, comprising:
memory means for storing a stereoscopic picture data including a right eye picture and a left eye picture;
display means for displaying said stereoscopic picture based on said stereoscopic picture data stored in said memory means on a display screen; and
controlling means for controlling said display means to display said right eye picture and said left eye picture alternately on said display screen of the display means so as to have a parallax between said right eye picture and said left eye picture,
wherein said controlling means controls said display means to display a frame body having a parallax around said stereoscopic picture when said right eye picture and said left eye picture are alternately displayed on said display screen of the display means with the parallax.
